(19) United States
(12) Patent Application Publication
(10) Pub. No.: US 2026/0146869 A1
(43) Pub. Date: May 28, 2026

(54) Adaptive Sampling System for Time-Variant Numerical Measurements

(71) Applicant: The United States of America, as represented by the Secretary of the Navy, Arlington, VA (US)

(72) Inventor: Joshua Guthrie, Harkers Island, NC (US)

(21) Appl. No.: 19/177,864

(22) Filed: Apr. 14, 2025

Related U.S. Application Data
(60) Provisional application No. 63/640,339, filed on Apr. 30, 2024.

(51) Int. Cl. G01D 3/028; G01D 7/02; G01D 9/00

(52) U.S. Cl. CPC G01D 3/028; G01D 7/02; G01D 9/005

(57) ABSTRACT

An adaptive sampling system uses dynamic adjustment of sampling rates to efficiently capture aperiodic, time-variant numerical measurements. This system evaluates real-time data variability to modulate sampling frequency, ensuring that only significant data variations are recorded. This approach minimizes unnecessary data storage and processing, enhancing the efficiency of data transfer and analysis in systems requiring precise monitoring and control. The system for data acquisition prioritizes accuracy and resource optimization in fluctuating conditions.

### STATEMENT OF GOVERNMENT INTEREST

The invention described herein may be manufactured and used by or for the Government of the United States of America for governmental purposes without payment of any royalties thereon or therefor.

### BACKGROUND

Current analyzers commonly sample dynamic digital data at a fixed rate, focusing on a maximum frequency of data collection, technique called oversampling. Through various types of filtering (e.g. decimation or peak value), that data will be screened down statically and the data collected will be reduced to a single numerical value. Depending on the type of filtering used, that single numerical value can be reduced through a somewhat selective rejection of oversampling. Other mechanisms to screen down data involve envelope techniques like demodulation compare even to odd number samples and combine the results. Current techniques to process the amount of data from oversampling, then decrease that amount of data to derive a scalar value, but in doing so, creates massive amounts of high-speed measured data problems. For example, the amount of data processed by the system to conduct oversampling leads to data problems such as higher costs due to a need for larger storage capacities, storage solutions with larger capability, specialized hardware and components, and faster components (e.g. upgraded network infrastructure, faster processors, and larger memory capacities) associated with greater processing demands. That specialized hardware also faces compatibility issues with existing hardware, software, or communication protocols, making it difficult to adapt them to different applications or to upgrade individual components without affecting the entire system. Those current techniques are also more susceptible to noise, interference, and other environmental factors. The quality and accuracy decreases when scan rates internal to smart sensors are tied to the devices output sample rate.

Given this, known technology in data acquisition systems therefore often involves inflexible fixed-rate sampling methods, which can lead to inefficiencies in data storage and processing. These traditional systems capture data at constant intervals, regardless of the significance of change between samples, resulting in the collection of large volumes of redundant data. This inefficiency is particularly problematic in environments where the parameters being monitored exhibit aperiodic, time-variant behavior. Systems such as those detailed in Feizi-Khankandi (U.S. Pat. No. 9,294,113), Mann (U.S. Pat. No. 10,175,070), Mermoud (U.S. Pat. No. 10,346,277), Perez (U.S. Pat. No. 9,395,708), and Wang (U.S. Pat. No. 7,579,984), each of which is hereby incorporated by reference in their respective entireties, are evidence of such challenges in the field of data acquisition analysis.

Therefore, there is a need for a more adaptable data acquisition method that can dynamically adjust to the variability of the data, ensuring that only meaningful changes are recorded, so as to optimize the use of storage and processing resources, while improving the efficiency and effectiveness of data collection in dynamic environments.

### SUMMARY

The present invention is directed to a system and method that includes, in one embodiment, a customized programmable application specific logic array that satisfies those needs to lower costs (e.g. lower storage requirements, increased system efficiency, adaptability to future requirements, and reduce latency processing), increased data quality with intelligent downsampling 104 and a focus on internal sample rates, enhanced battery life for portable devices, and less data allows easier implementation of advanced encryption and security protocols. In another embodiment, an adaptive sampling system having features of the present invention comprises a customized programmable application specific logic array, at least one customized aperiodic measurement sensor, and an output module. The customized aperiodic measurement sensor measures physical conditions based on aperiodic numerical values. The customized programmable application specific logic array contains various forms and includes a 3-D curve associated with safety parameters. These and other features, aspects, and advantages of the present invention will become better understood with reference to the following description and appended claims.

### BRIEF DESCRIPTION

Further advantages of the invention are apparent by reference to each detailed description in conjunction with each figure wherein:

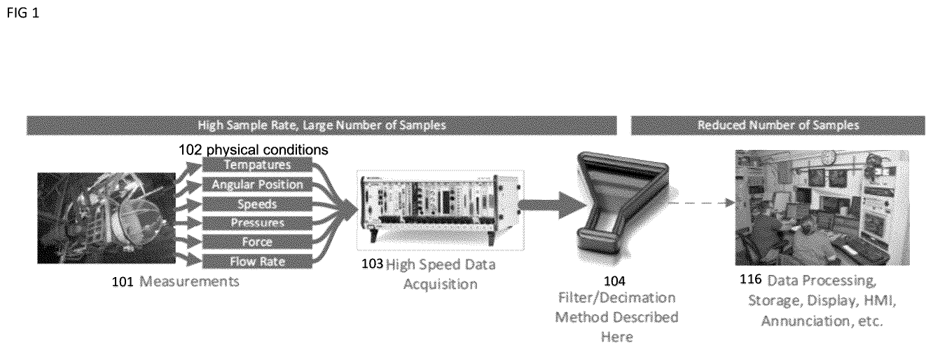

FIG. 1 depicts a data path block diagram of one embodiment that places this customized programmable application specific logic array between the high-speed acquisition system and the Data Processing, Storage, Display, HMI, Annunciation, etc. portions of the system.

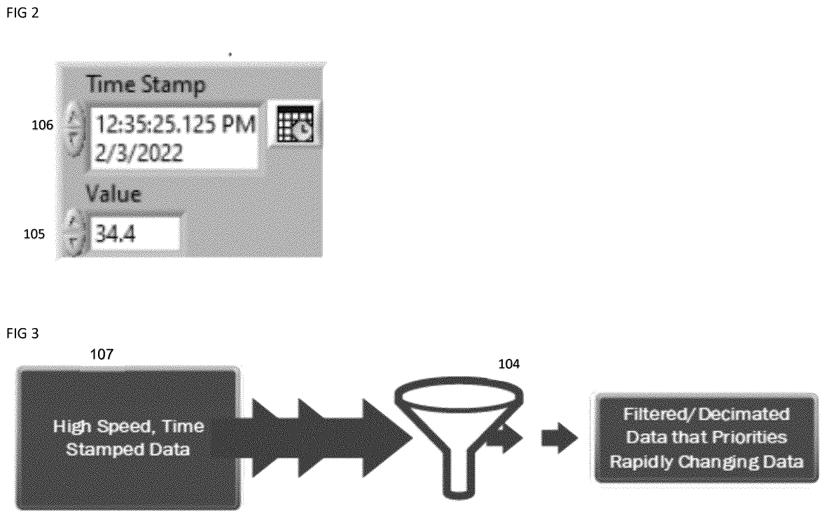

FIG. 2 depicts a visual representation of a sample in one embodiment.

FIG. 3 depicts one embodiment where a block diagram of high speed and time stamped data transitioning to filtered/decimated data that prioritizes rapidly changing data.

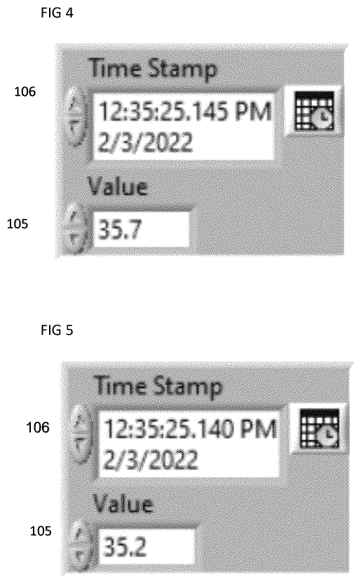

FIG. 4 depicts a new sample from downsampling consistent with current analyzers in one embodiment.

FIG. 5 depicts one embodiment with an example of the output of filtered.

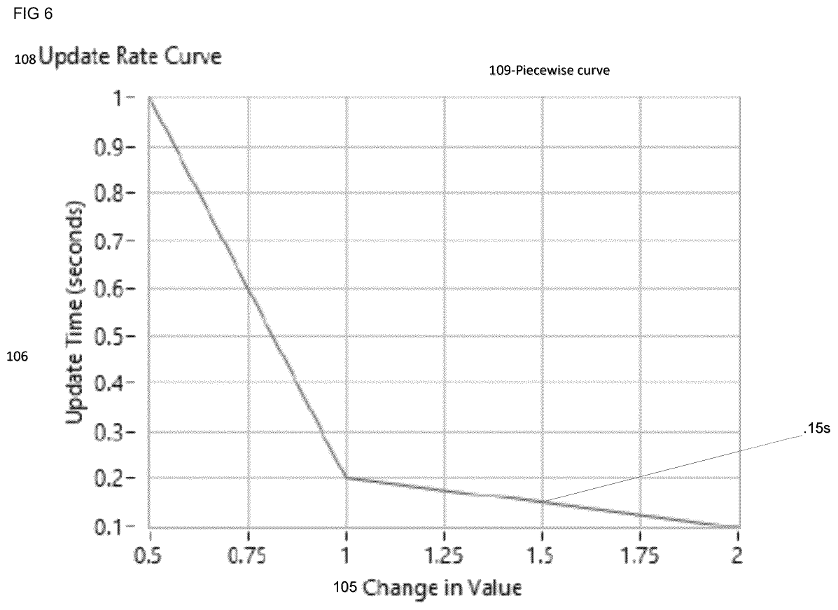

FIG. 6 depicts an update rate curve associated with one embodiment of the customized programmable application specific logic array that allows versatile adaption to specific application requirements.

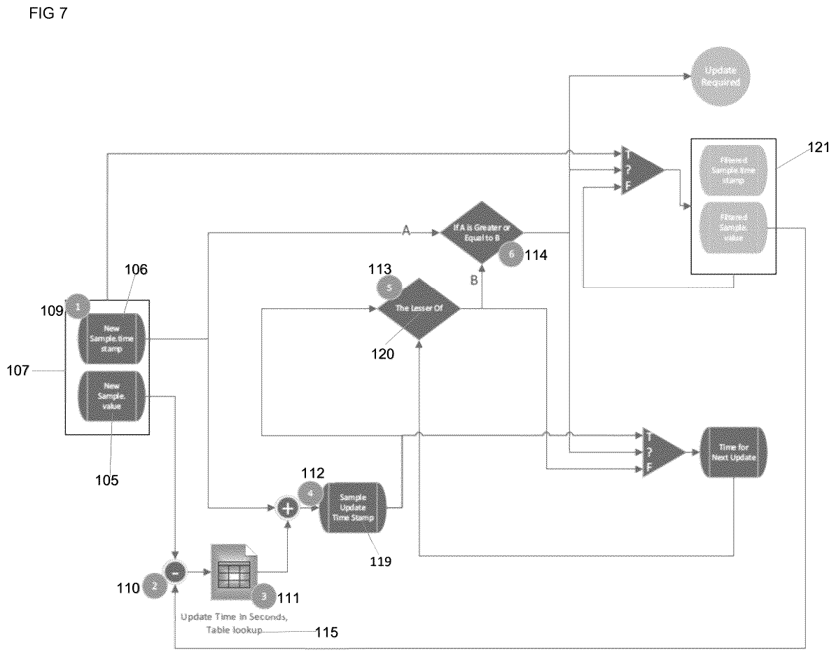

FIG. 7 depicts one embodiment with a block diagram with dynamic adjustment of sampling rates to efficiently capture aperiodic, time-variant numerical measurements.

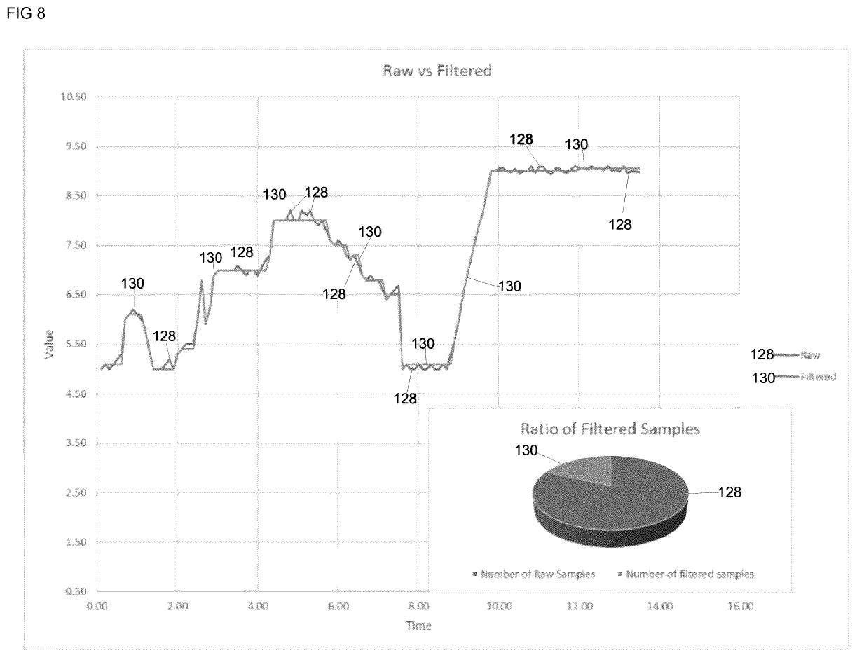

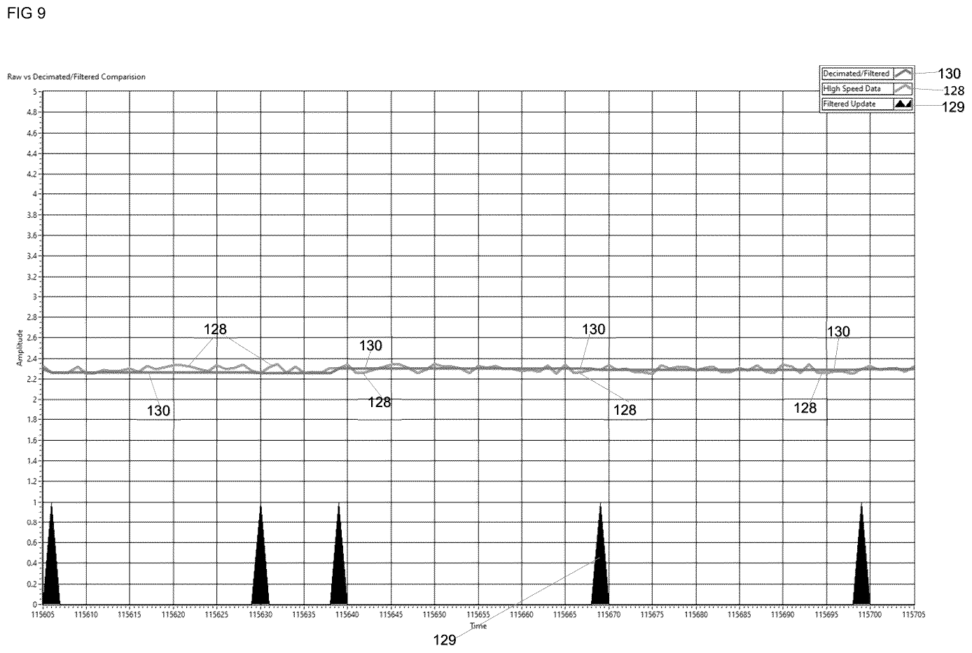

FIG. 8 depicts one embodiment with raw versus filtered sample data chart with a ratio of filtered samples.

FIG. 9 depicts one embodiment response from a Simulated Thermocouple at approximately steady state.

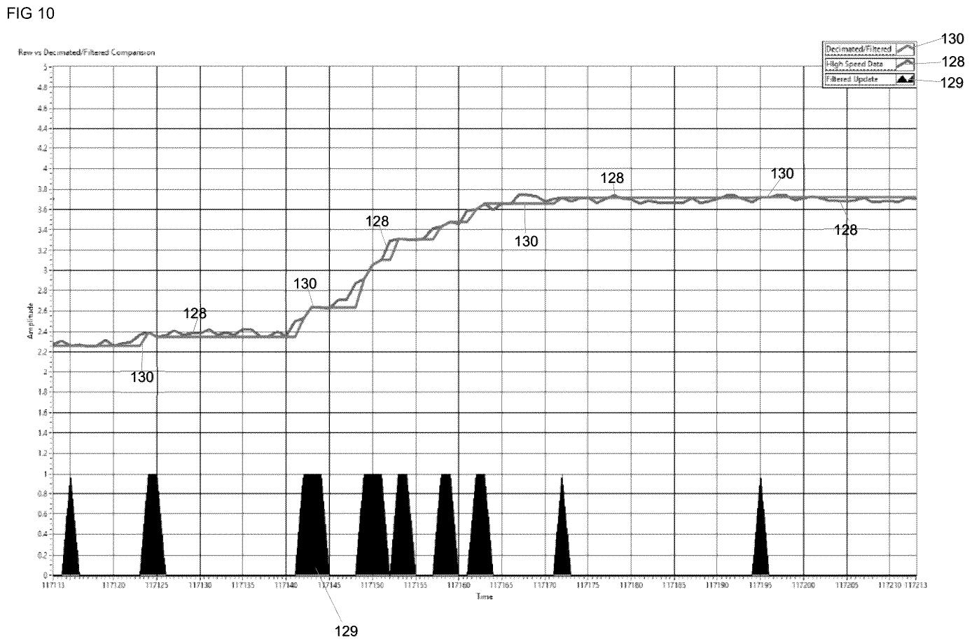

FIG. 10 depicts one embodiment response from a Simulated Thermocouple with a rapid rise in temperature. We would have lost almost all the fidelity of the transient event if static updates were used.

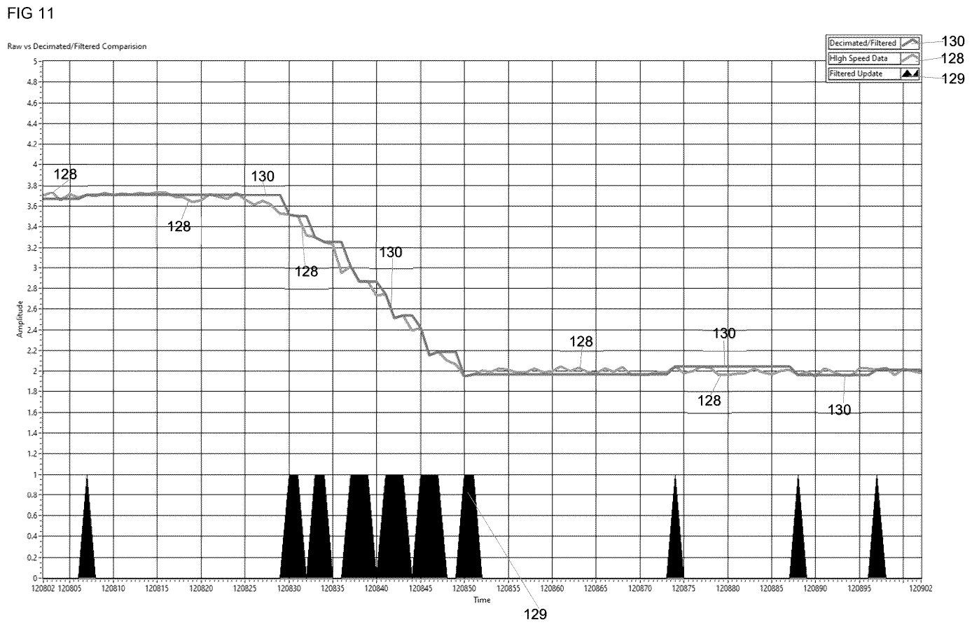

FIG. 11 depicts one embodiment response from a Simulated Thermocouple with a rapid decrease in temperature.

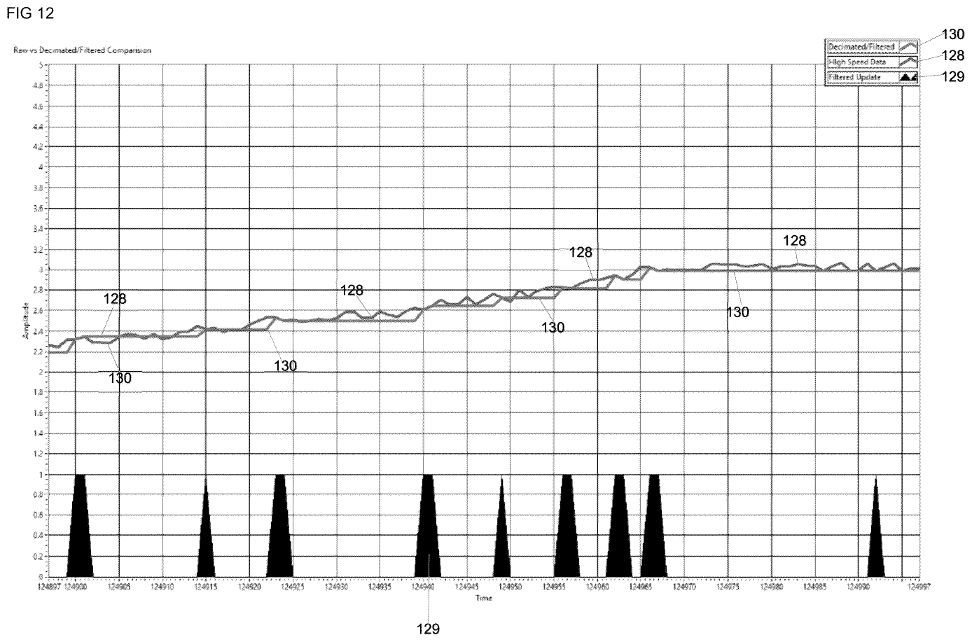

FIG. 12 depicts one embodiment response from a Simulated Thermocouple with a slow rise in temperature.

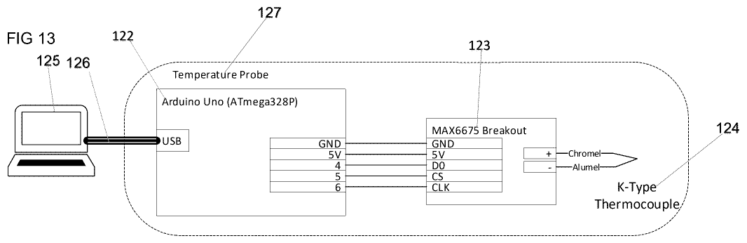

FIG. 13 depicts one embodiment of a circuit diagram.

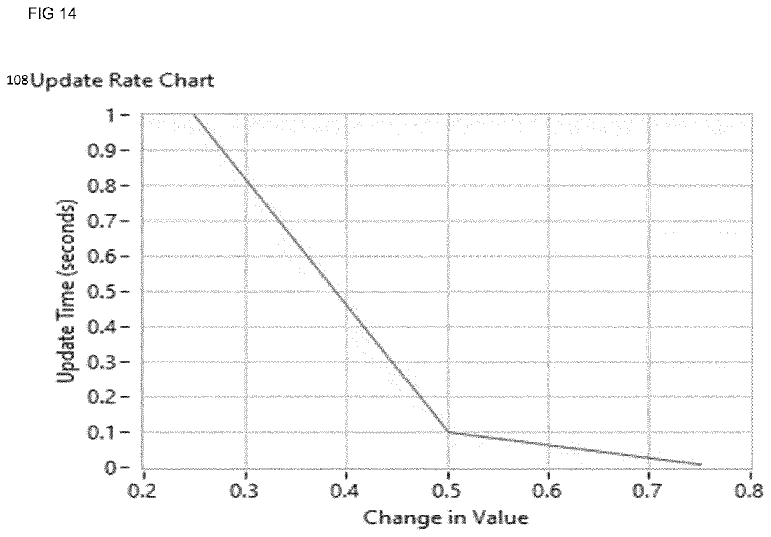

FIG. 14 depicts an Update Rate Curve for temperature classification or rating T5 for a case study on an aircraft engine.

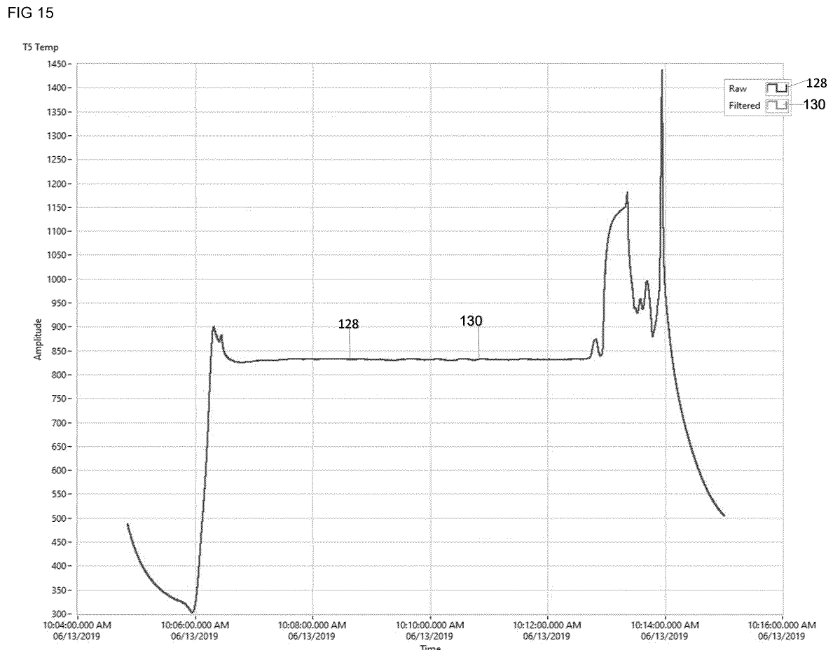

FIG. 15 depicts temperature classification or rating T5 from the aircraft engine case study with no loss of fidelity.

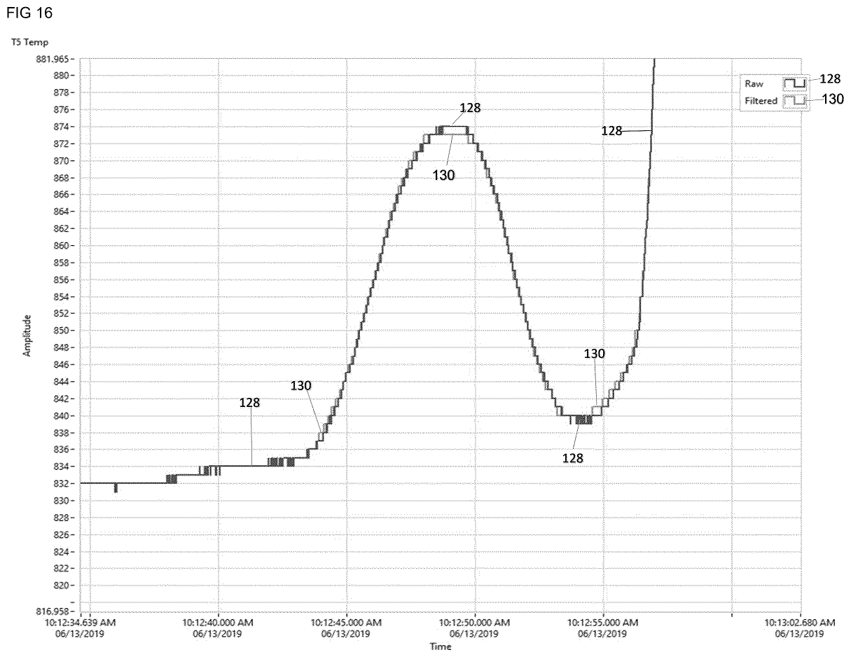

FIG. 16 also depicts temperature classification or rating T5 from the aircraft engine case study with no loss of fidelity.

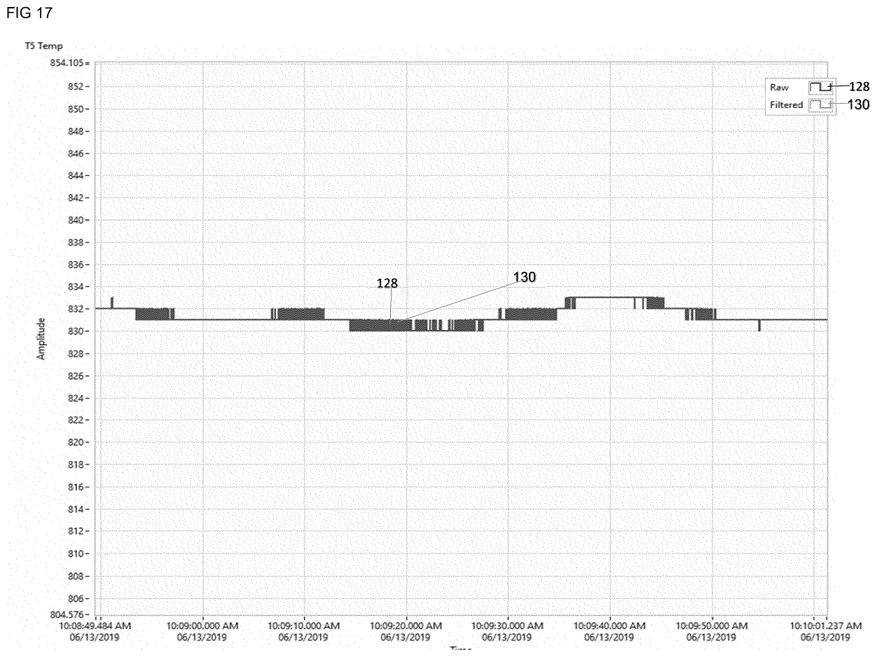

FIG. 17 also depicts temperature classification or rating T5 from the aircraft engine case study with no loss of fidelity.

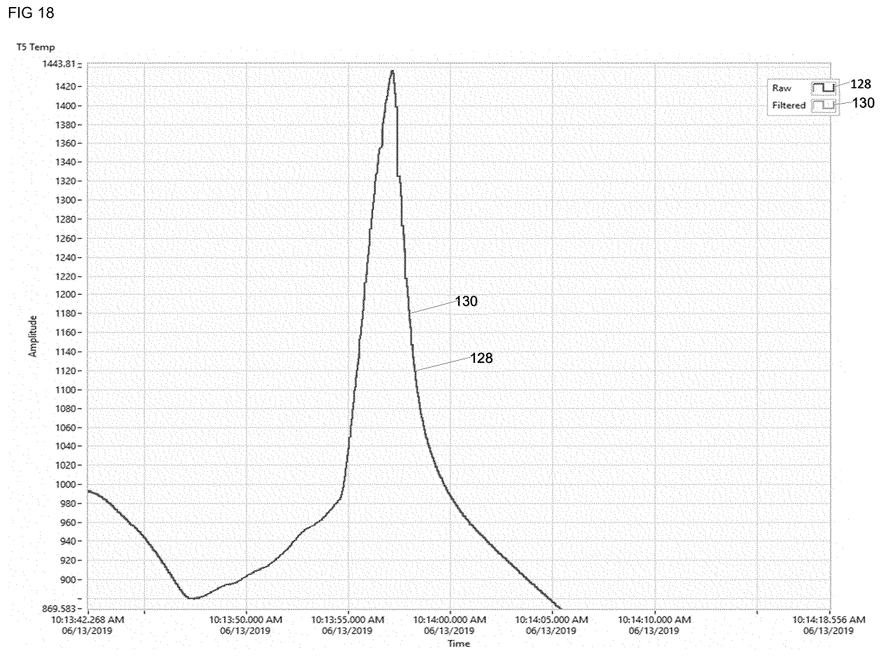

FIG. 18 also depicts temperature classification or rating T5 from the aircraft engine case study with no loss of fidelity.

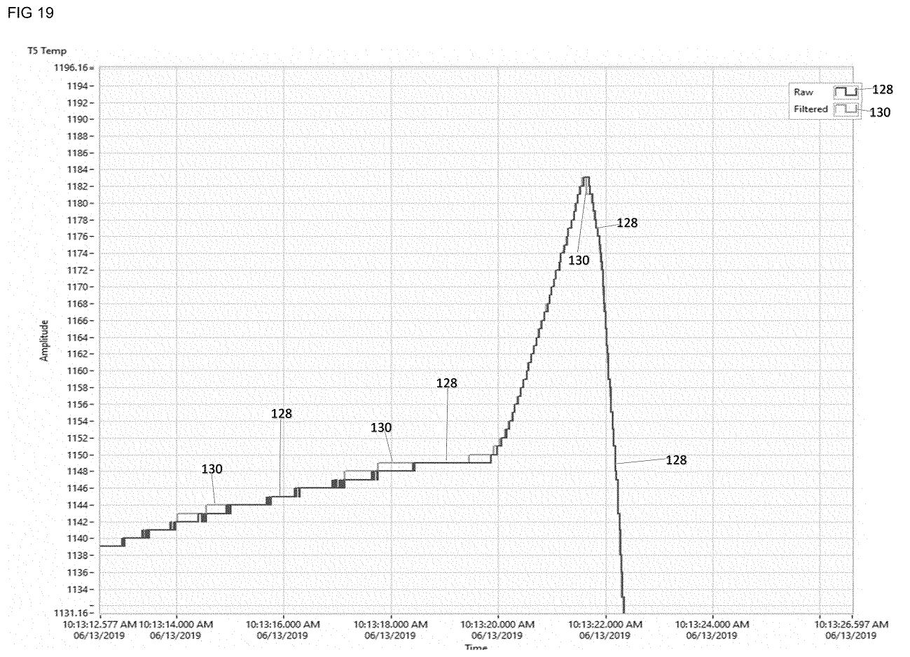

FIG. 19 also depicts temperature classification or rating T5 from the aircraft engine case study with no loss of fidelity.

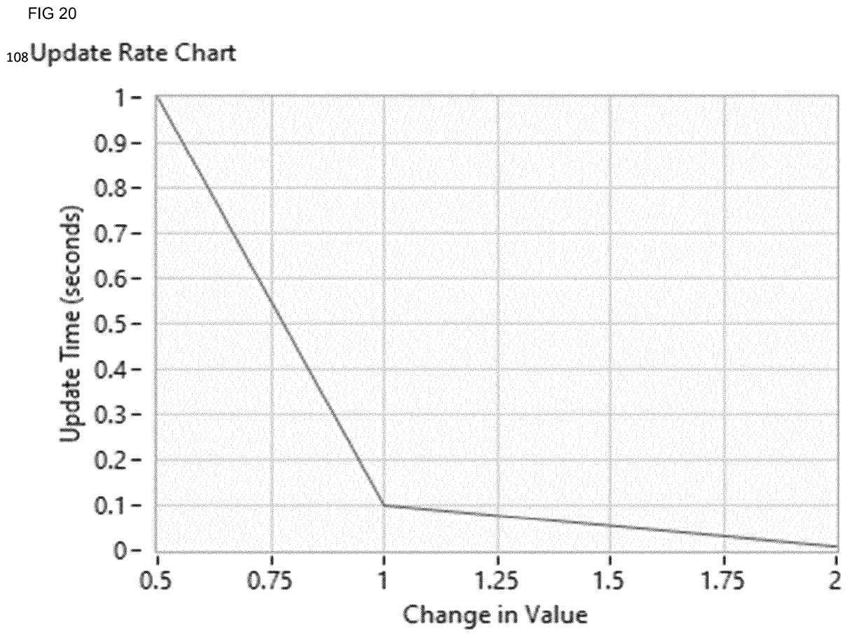

FIG. 20 depicts an Update Rate Curve for system hydraulic pressure for a case study on an aircraft engine.

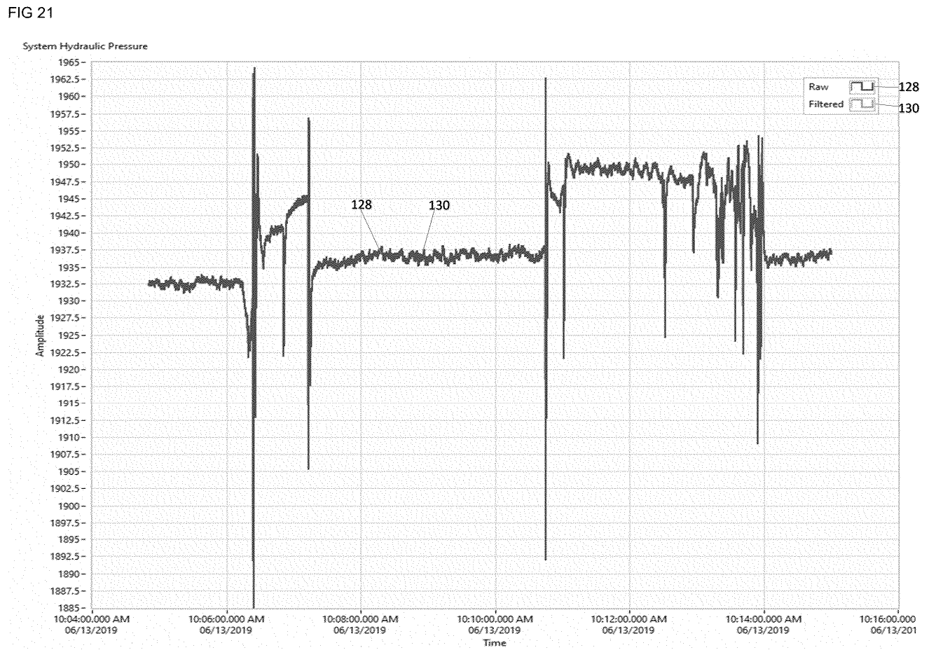

FIG. 21 depicts system hydraulic pressure from the aircraft engine case study with no loss of fidelity.

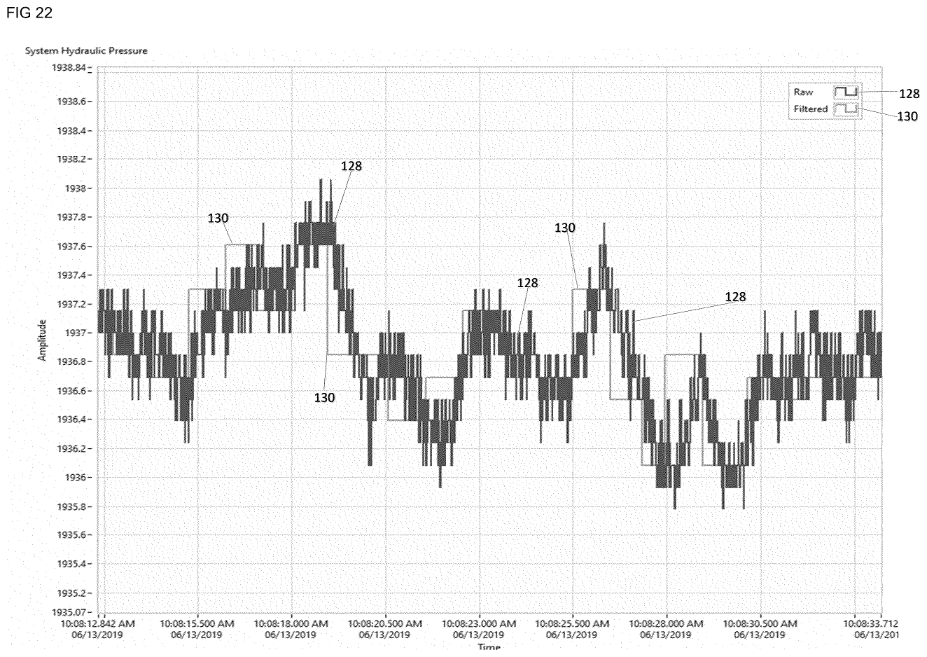

FIG. 22 also depicts system hydraulic pressure from the aircraft engine case study with no loss of fidelity.

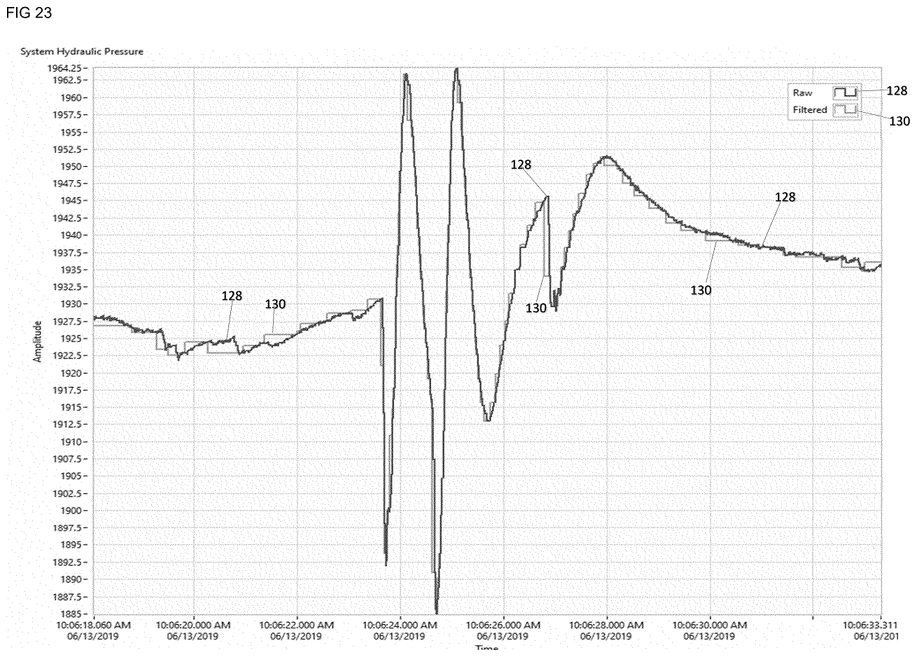

FIG. 23 also depicts system hydraulic pressure from the aircraft engine case study with no loss of fidelity.

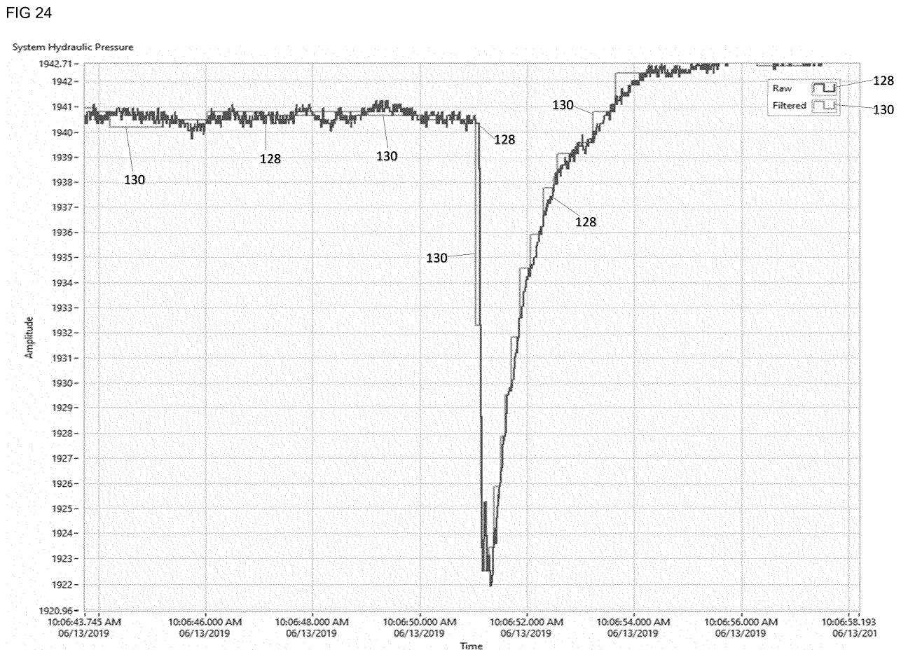

FIG. 24 also depicts system hydraulic pressure from the aircraft engine case study with no loss of fidelity.

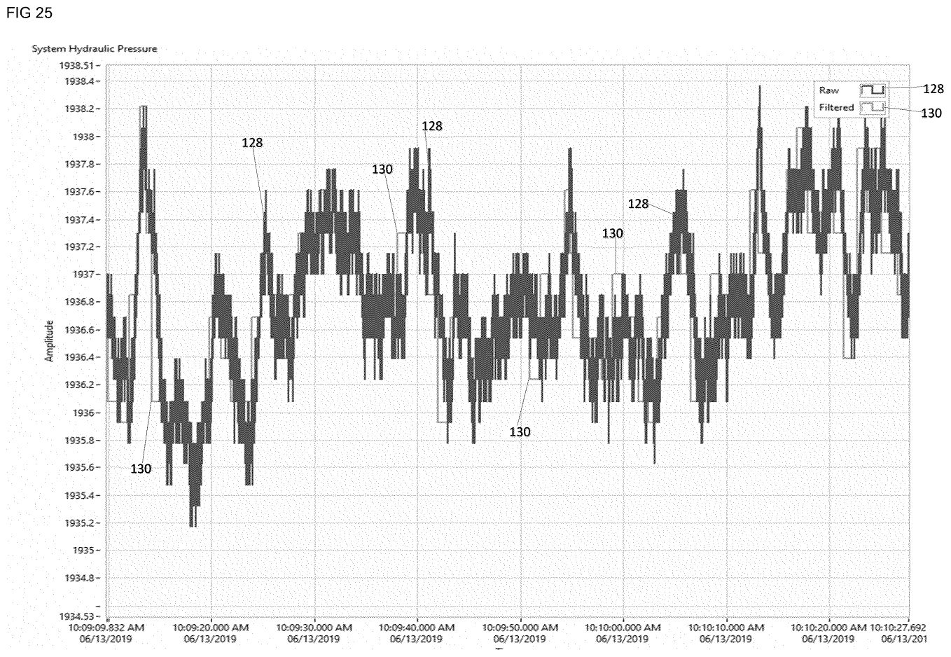

FIG. 25 also depicts system hydraulic pressure from the aircraft engine case study with no loss of fidelity.

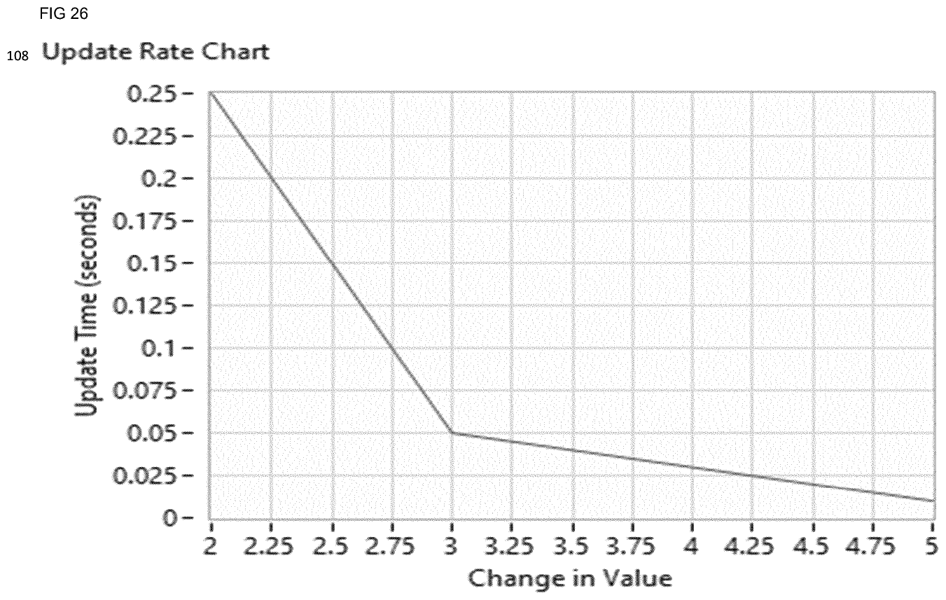

FIG. 26 depicts an Update Rate Curve for power turbine speed for a case study on an aircraft engine.

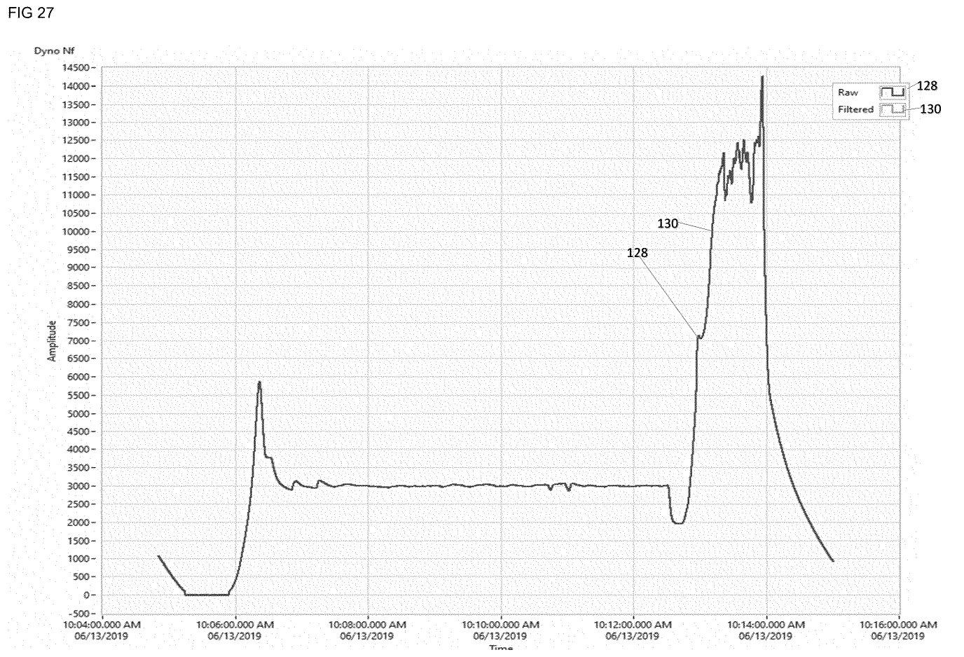

FIG. 27 depicts power turbine speed from the aircraft engine case study with no loss of fidelity.

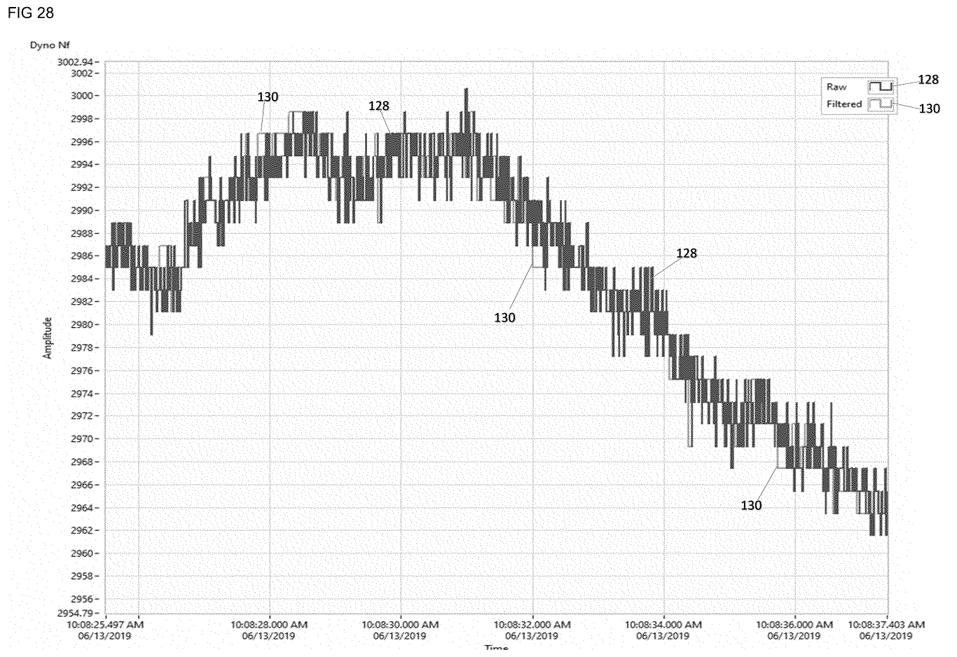

FIG. 28 also depicts power turbine speed from the aircraft engine case study with no loss of fidelity.

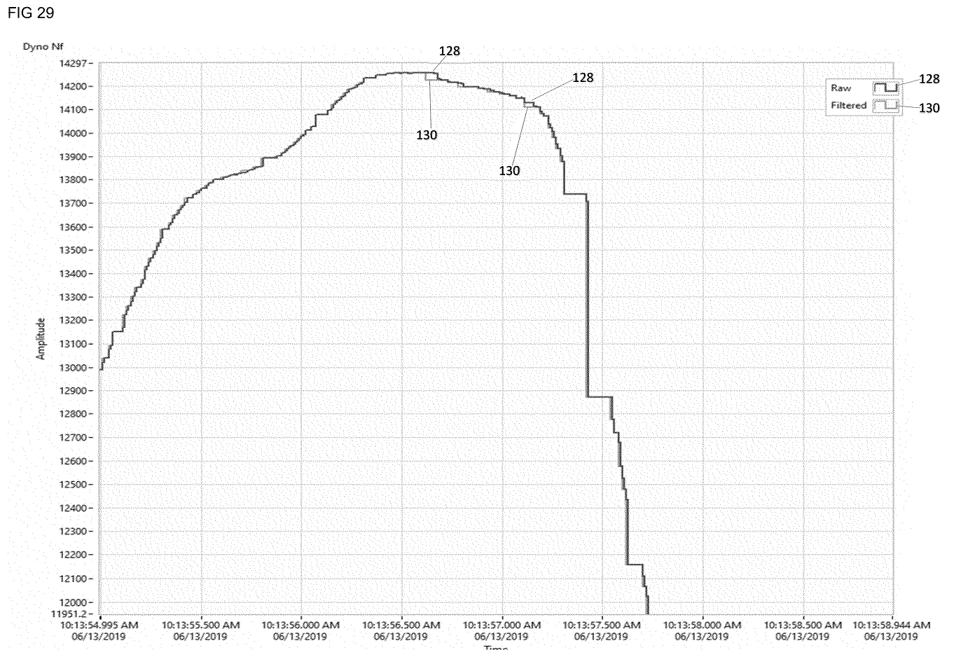

FIG. 29 also depicts power turbine speed from the aircraft engine case study with no loss of fidelity.

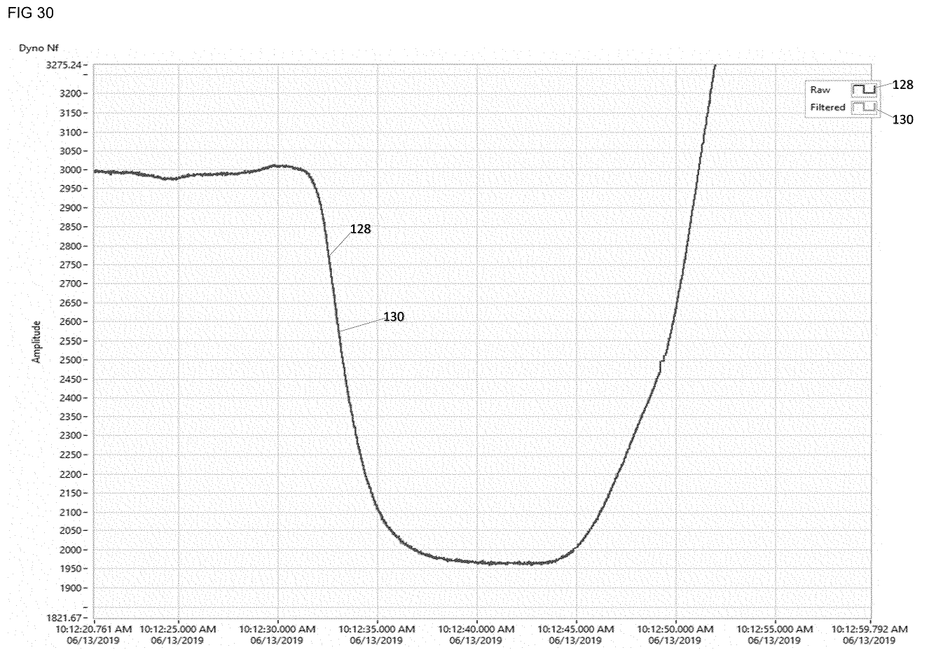

FIG. 30 also depicts power turbine speed from the aircraft engine case study with no loss of fidelity.

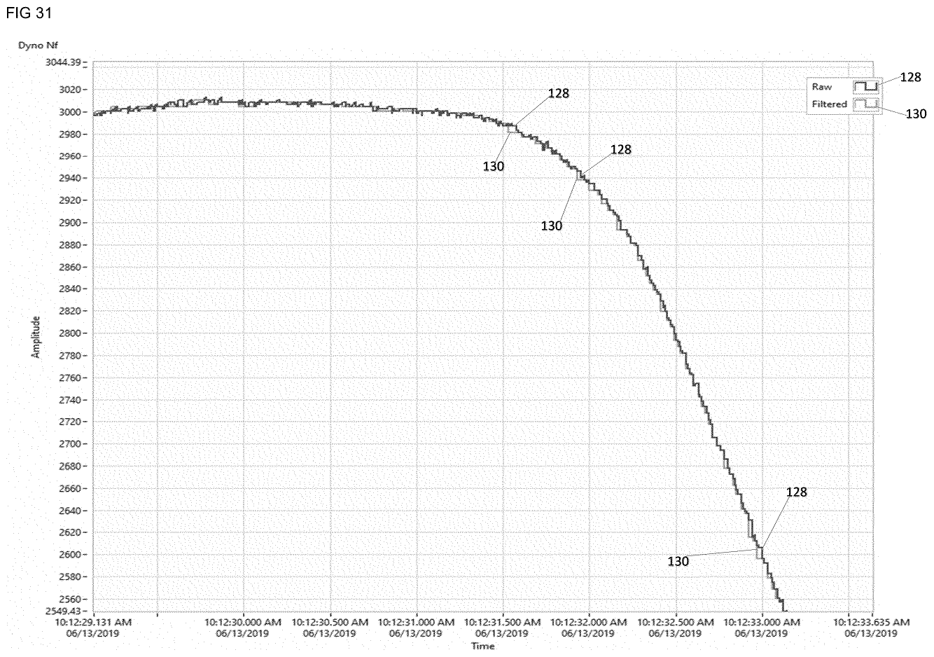

FIG. 31 also depicts power turbine speed from the aircraft engine case study with no loss of fidelity.

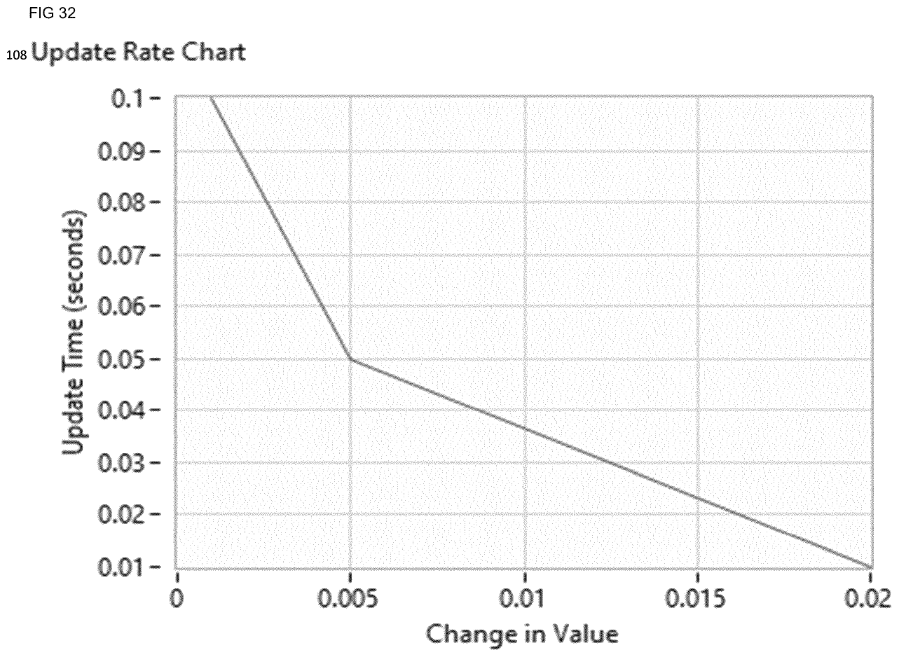

FIG. 32 depicts an Update Rate Curve for pressure for a case study on an aircraft engine.

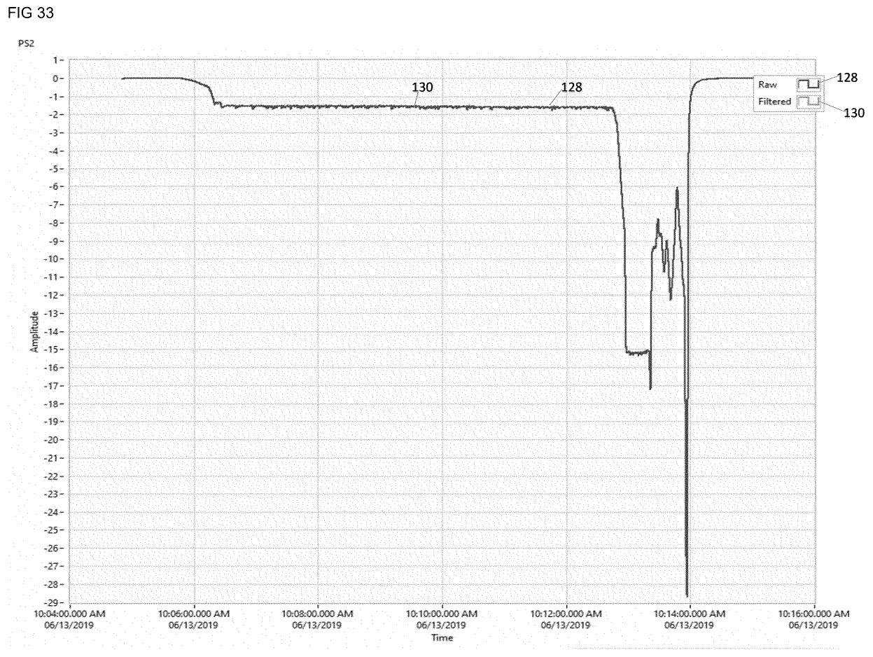

FIG. 33 depicts pressure from the aircraft engine case study with no loss of fidelity.

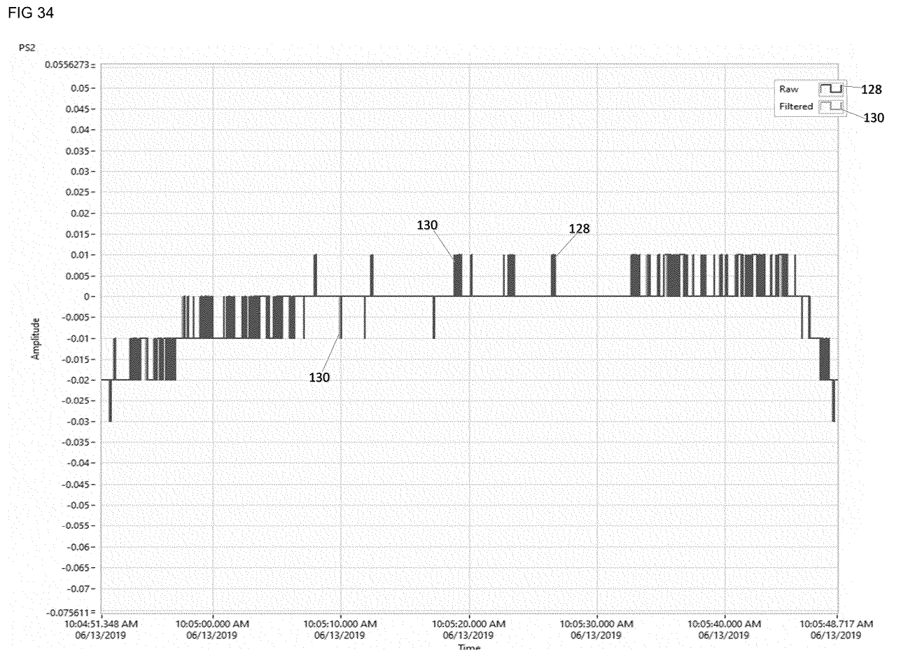

FIG. 34 depicts pressure from the aircraft engine case study with no loss of fidelity.

FIG. 35 depicts pressure from the aircraft engine case study with no loss of fidelity.

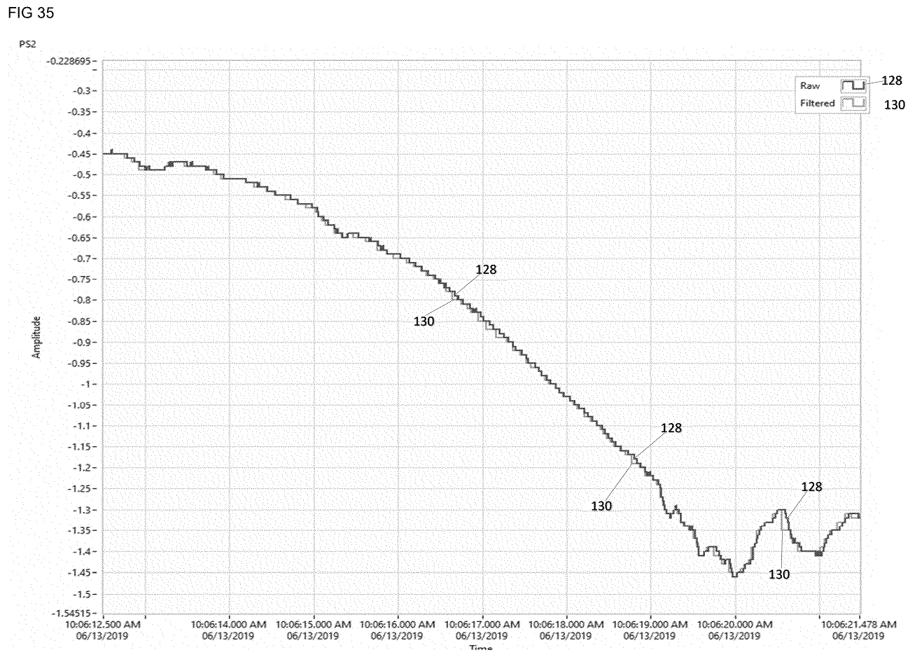

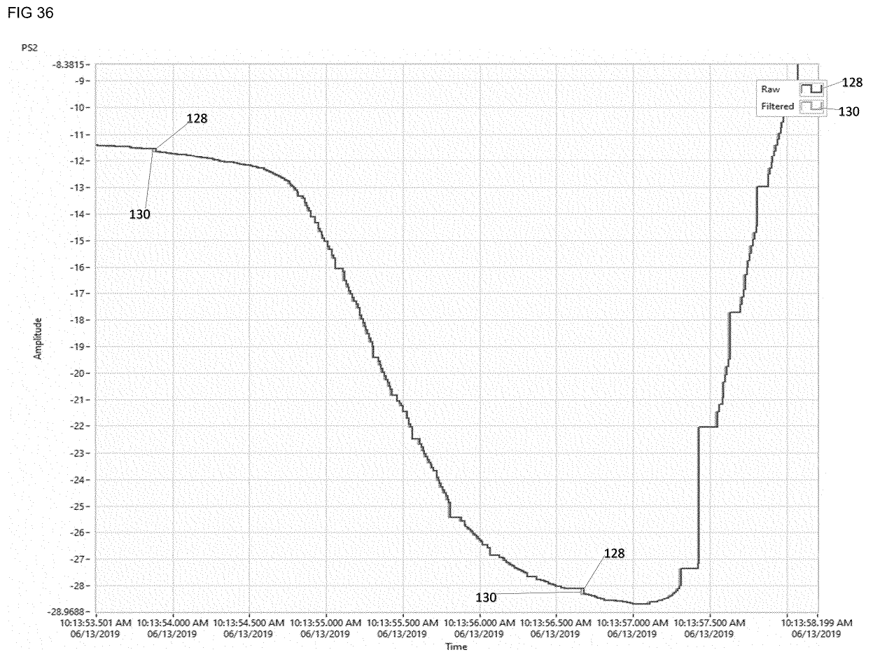

FIG. 36 depicts pressure from the aircraft engine case study with no loss of fidelity.

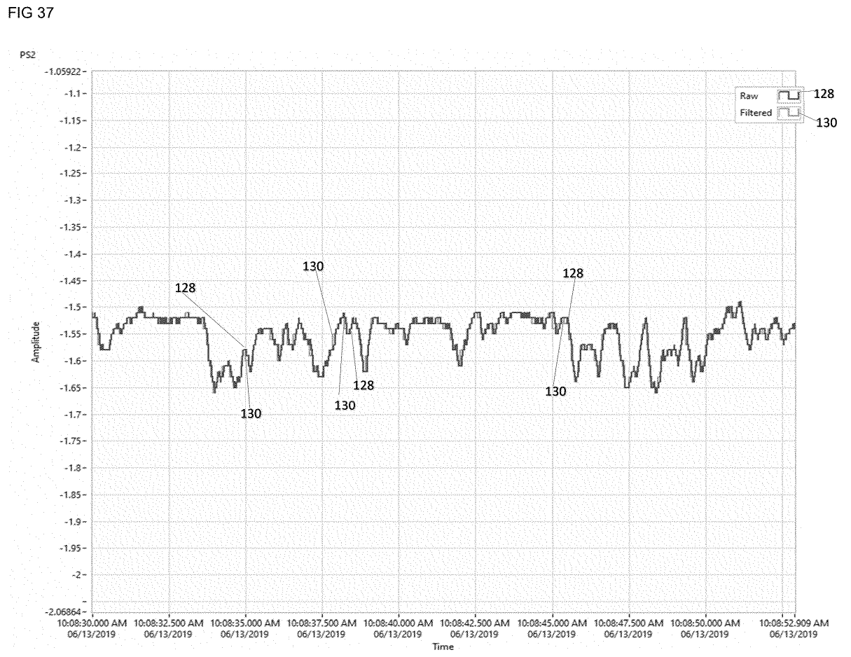

FIG. 37 depicts pressure from the aircraft engine case study with no loss of fidelity.

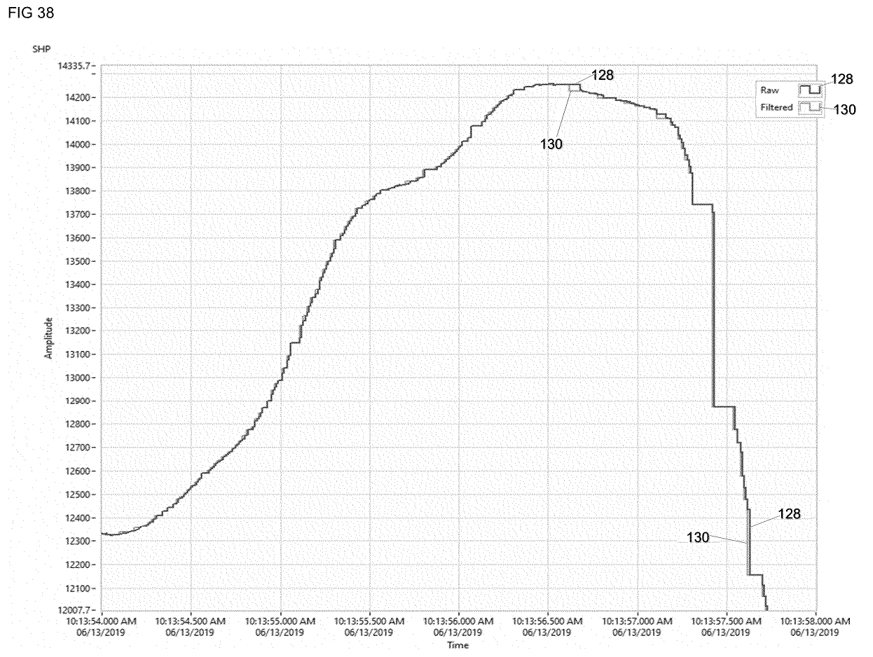

FIG. 38 also depicts power turbine speed from the aircraft engine case study using the adaptive sampling system to illustrate a Static Update Rate using the same number of samples, but evenly spaced.

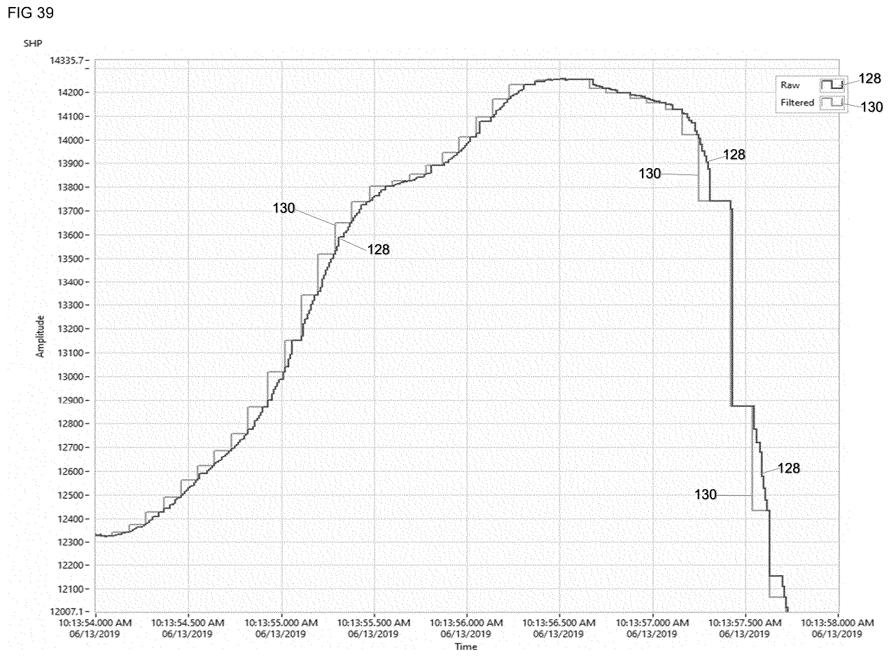

FIG. 39 also depicts power turbine speed from the aircraft engine case study using the traditional sampling method to illustrate a Static Update Rate using the same number of samples, but evenly spaced.

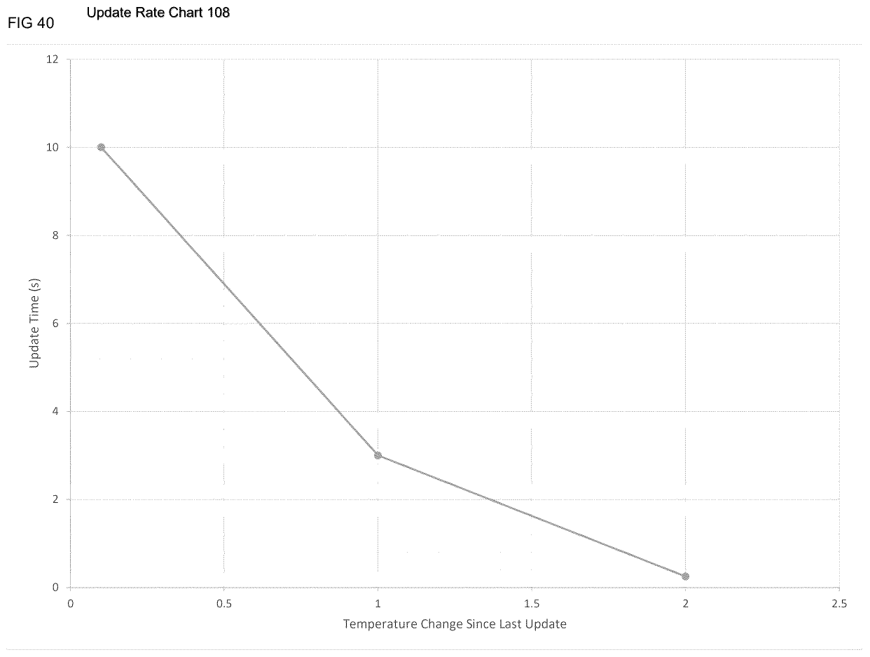

FIG. 40 depicts an Update Rate Curve associated with hardware implementation

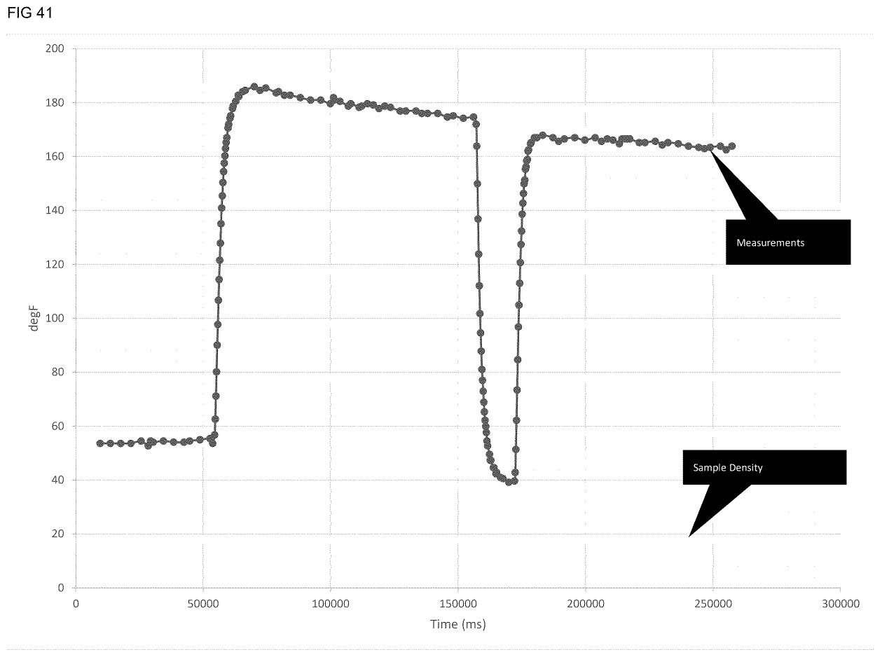

FIG. 41 depicts temperature changes associated in the hardware implementation of the adaptive sampling system

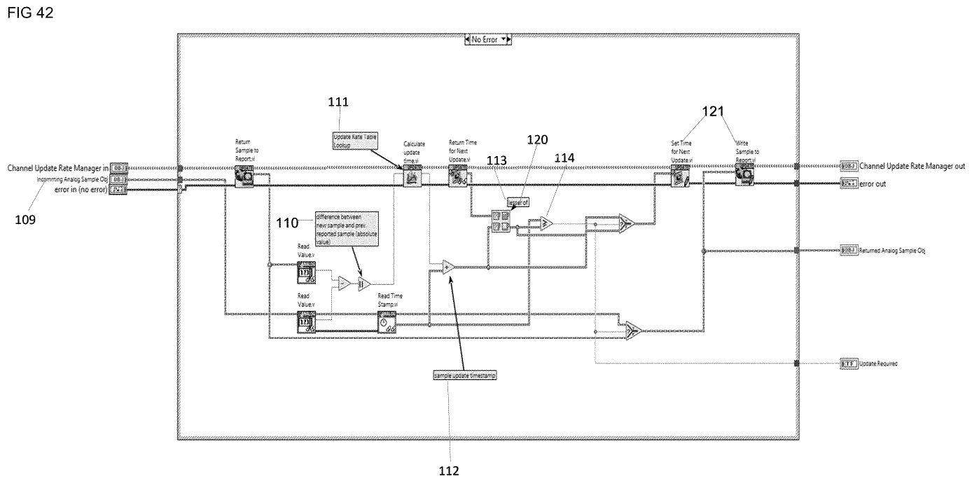

FIG. 42 depicts software implementation associated with the adaptive sampling system.

### DETAILED DESCRIPTION

The present invention provides an innovative approach to data collection in environments where measurements are aperiodic and conditions fluctuate. By dynamically adjusting the sampling rate based on real-time analysis of data variation, it significantly reduces the volume of redundant data captured compared to conventional fixed-rate sampling systems. This efficiency translates into lower storage requirements and faster data processing, enabling more effective monitoring and decision-making in industrial applications. It offers a superior alternative to known Data Acquisition (DAQ) Systems by ensuring data accuracy and resource optimization, further distinguishing itself from existing technologies through its adaptability to changing data patterns.

At its broadest level, the present invention is an adaptive sampling system for generating downsampled time-variant numerical measurements of physical conditions. All embodiments of the system have features which include a customized programmable application specific logic array comprises at least one customized aperiodic measurement sensor for physical conditions 102 and an output module customizable to an application-specific rate curve used for downsampling with a magnitude of error of last reported value. The adaptive sampling system has a multitude of embodiments as measurements of physical conditions include at least one aperiodic time variant numerical value. The application-specific rate curve embedded within the customized programmable application logic array is chosen from various forms including linear form, piecewise form, or curved form. That application-specific rate curve embedded within the customized programmable application logic array further includes a 3-D curve built from safety parameters.

The novel system is highly configurable and as such, has many industrial applications where sensors or other peripherals gather quantities of data. For example, the following is a non-exclusive listing of some possible fields and applications: Defense and Military applications focused on advanced surveillance, reconnaissance, and communication systems that require efficient data acquisition and processing in variable conditions; Aerospace, for example, in aircraft and spacecraft design, manufacturing, and maintenance, where real-time data monitoring is essential for safety and performance optimization; Automotive manufacturing, especially in developing autonomous and connected vehicle technologies, where adaptive data sampling can enhance sensor data processing and vehicle diagnostics; Energy applications, including renewable energy companies and traditional power generation fields, where monitoring and optimizing performance in variable environmental conditions are critical; Industrial automation and manufacturing, with a focusing on improving process control, predictive maintenance, and operational efficiency through smarter data acquisition systems; Environmental monitoring and research, such as climate research, pollution monitoring, and ecological studies, or other applications where adaptive sampling could vastly improve data quality and resource efficiency; Healthcare and biomedical research, where real-time monitoring of patient data is conducted or when conducting studies with variable biological data; Maritime and oceanographic applications, such as sea condition monitoring, underwater exploration, and marine biology research, where adaptive sampling can address the challenges of collecting data in such unpredictable environments; Smart city technology solutions for urban management, including traffic monitoring, environmental sensing, and infrastructure maintenance, where efficient data collection is key to operational success; Industrial Sensors that can be embedded with the novel adaptive sampling system in industrial sensors, in order to enhance the precision and efficiency of data collection in varying environmental conditions, thereby enabling sensors to dynamically adjust their sampling rates based on the significance of data changes, reducing unnecessary data storage and processing, thereby leading to improved system performance, optimized resource usage, and extended sensor lifespans by avoiding overload and minimizing power consumption, all while enhancing the accuracy of real-time monitoring and decision-making processes, crucial for maintaining high operational standards in industries such as manufacturing, energy, and aerospace.

Data Acquisition (DAQ) Devices, which, when embedded in one embodiment, the adaptive sampling system in DAQ Systems could significantly enhance efficiency and accuracy by allowing DAQ Systems to automatically adjust sampling rates based on real-time data variability, reducing unnecessary data collection, transmission and processing, all of which leads to more efficient use of storage and computational resources, improved data quality by focusing on significant changes, and potentially extends the lifespan of storage mediums by minimizing the volume of data written, as well as enabling faster response times in applications requiring real-time monitoring and control, making it invaluable in dynamic and critical environments. In one embodiment, embedding this adaptive sampling system in Programmable Logic Controllers (PLCs) would significantly enhance their functionality in industrial automation and control processes. It would allow PLCs to optimize data collection from sensors and actuators by adjusting sampling rates in real-time based on data significance. This could lead to more efficient use of network and processing resources, reduce the amount of data that needs to be handled, and improve decision-making accuracy by focusing on relevant changes. Consequently, it would enable more responsive and adaptive control strategies, leading to increased operational efficiency and potentially reducing wear and tear on machinery due to more precise control actions; and Test and measurement integrators, who would benefit from more precise and efficient testing processes by adjusting the data collection rate in real-time based on the significance of the data changes. This leads to reduced data redundancy, optimized test durations, and enhanced analysis capabilities, ensuring higher quality results while minimizing resource consumption and improving the overall reliability and effectiveness of testing operations. When provisioned as such, implementation of the novel system and method would reduce storage burdens, network infrastructure, processing requirements, all while allowing additional measurements and diagnostic information.

Accordingly, the present invention may be instantiated in associated hardware, or alternatively on the inside of devices such as Acquisition Devices. Additional value would, in one embodiment, be in implementing such a solution on/in the actual sensors, especially given that many of the sensors used in industry are digital. Having adaptive sample rates would be a great feature for such devices, where say, sensor manufacturers could internally customize the novel approach by developing application-specific rate curves that are appropriate updates for their devices (i.e. normal updates, aggressive updates). Putting adaptive downsampling on sensors directly would have benefits. The first benefit is Reduced Data Volume: By implementing downsampling close to the sensor level, the volume of data that needs to be transmitted, processed, stored, and displayed is significantly reduced. This leads to lower storage requirements and potentially lower costs for data management. The second benefit is Improved System Efficiency: Downsampling at the hardware level can improve the overall efficiency of the data acquisition system. It allows for faster data processing times since less data needs to be processed. This can be critical in real-time applications where timely data processing is essential. The third benefit is Enhanced Battery Life for Portable Devices: For battery-powered devices, reducing the amount of data that needs to be processed and stored can lead to significant improvements in battery life, making the system more sustainable and portable. The fourth benefit is Customization and Flexibility: Offering adaptive sample rates and updated rate curves tailored to specific applications or environments can provide customers with the flexibility to optimize their systems for their particular needs. The fifth benefit is Improved Data Quality: Intelligent downsampling can focus on preserving the quality and integrity of the data that is most relevant to the application, reducing noise and irrelevant information, which can lead to more accurate analyses and decisions. The sixth benefit is Scalability and Future-Proofing: By implementing downsampling at the sensor level, systems can be designed to be scalable and adaptable to future requirements. As data needs grow or change, the system can adjust without the need for significant hardware overhauls. The seventh benefit is Low-Latency Processing: Implementing the downsampling process in hardware can significantly reduce latency, making the system more responsive and suitable for real-time applications. The eighth benefit is Energy-Efficient Design: Optimizing the hardware for low power consumption, especially important for portable or remote sensing applications. The ninth benefit is Internal Sensor Scan Rate Manipulations: In current implementations, the scan rates internal to such smart sensors are tied to the devices output sample rate. The approach allows for the divorce of this relationship allowing for the internal sample rates to be modified (often increased) to better suit accuracy and responsiveness. The tenth benefit is Security: Less data makes security easier. Becomes easier to implement advanced encryption and security protocols at the sensor level to ensure data integrity and privacy, especially in sensitive applications.

In any illustrative implementation, one advantage of the present invention is the novel downsampling whereby customizing the sample rate of large data streams can have the following advantages. The first advantage is Reduced Data Storage Requirements: Downsampling high sample rate data leads to a reduction in the amount of data that needs to be stored. This is particularly beneficial when dealing with large datasets, helping to save storage space and associated costs. The second advantage is Lower Computational Load: Operating at a lower sample rate reduces the computational load on the system. This can lead to improved efficiency and reduced power consumption, making the system more suitable for resource-constrained environments. The third advantage is Improved Signal Processing Efficiency: Downsampling data simplifies subsequent signal processing tasks. With fewer data points to process, algorithms can operate more efficiently, resulting in faster computation times and lower processing overhead. The fourth advantage is Simplified Data Transmission: Transmitting data at a lower sample rate is more bandwidth-efficient. This can be advantageous in communication systems, reducing the demands on data transmission channels and facilitating easier integration with existing infrastructure. The fifth advantage is Enhanced Signal-to-Noise Ratio (SNR): This novel downsampling approach can improve the signal-to-noise ratio by reducing high-frequency noise components that may not be of interest in the application. This can enhance the overall quality of the signal for subsequent analysis.

In one embodiment, embedding a downsampling system directly onto sensors presents a transformative approach to data acquisition and management. This integration allows for real-time adaptive sampling, where the sensor itself dynamically adjusts its data capture rate based on pre-defined or real-time analyzed conditions, optimizing for both accuracy and efficiency. Such an approach minimizes data redundancy and maximizes relevance, significantly reducing the load on subsequent processing and storage systems. By customizing this functionality at the sensor level, manufacturers can offer highly tailored solutions, enhancing the sensor's utility across various applications and environments, and providing end-users with scalable, precision-driven data management tools.

The adaptive sampling system is executed utilizing customized programmable application specific logic array equipped to perform the process, logic and computations outlined herein. This process is adaptable to both software and hardware implementations, encompassing a spectrum of electronic hardware configurations, including but not limited to Field-Programmable Gate Arrays (object and initializes variables), Application-Specific Integrated Circuits (ASICs), Printed Circuit Boards (PCBs), and other forms of general electronic hardware. Such implementations can seamlessly integrate into various locations within a system, demonstrating versatility in deployment.

In one embodiment, data typically originates in real world sensors as measurements 101. See FIG. 1. By adjusting a table across many measurements independently, a system developer can prioritize certain measurements of specific physical conditions 102 over others. For example, in one embodiment, outdoor temperature may not be as important as torque so the update rate table for outdoor temperature can be far less aggressive than the one created for torque. Those physical conditions 102 are chosen from the group comprising at least one of the following aperiodic, time variant numerical values 105 of: temperature, torque, angular position, speed/velocity, pressure under fluctuating environmental conditions, or flow rate under fluctuating environmental conditions, humidity, viscosity, electrical conductivity, voltage, current, magnetic flux density, luminous intensity, radiation levels, sound pressure levels, soil moisture content, air quality index, strain, particle flux, particle concentration in a medium, wind speed, salinity, pH level, wave height, solar irradiance, thickness, length, distance, dew point, barometric pressure, concentration of gas levels, concentration of fluid levels, displacement, cloud cover, atmospheric visibility, heat flux, leave area index, vapor pressure, Albedo, ground water depth, electromagnetic field strength, bioluminescence intensity, evaporation rate, acceleration, objects/items/people that occupy a given area, aerosol optical depth, electrical resistance, Reynolds number, capacitance, or inductance.

Data from that group is subsequently digitized by a high-speed data acquisition system 103. A replacement for current methods of downsampling, decimating, and filter methods is placed between the high speed data acquisition system 103 and the Data Processing, Storage, Display, HMI, Annunciation, etc. 116 portions of the system. Intelligent downsampling or adaptive sampling system 104 is the filter/decimation method described has the most value the closer to the sensor (or other data source) that we implement it.

In one embodiment, a sample comprises a numerical value 105 and may have a timestamp 106. See FIG. 2. The timestamp denotes the precise moment in time when the numerical value 105 was recorded, measured, or generated. In each embodiment, each measurement 101 will create its own sample. See FIG. 3. In this way, it is possible for the measurement's update rates to be aperiodic, asynchronous from measured parameter to measured parameter (usually described as a channel), and to have variable update rates within the measured parameters. With minimal care, last reported numerical values can be assumed to be non-changing until a new sample 107 is delivered to the system. Additionally, and with minimal care, last reported numerical values can be assumed to remain static between a new sample 107 and a last reported sample. In this process and in one embodiment, it is generally assumed the current sample and new samples 107 are presented in chronological order. The adaptive sampling system 104 can filter/decimate data that prioritizes rapidly changing data. New samples 107 enter the intelligent downsampling system 104 at a rate of acquisition. See. FIG. 3. In one embodiment, those new samples 107 receive a numerical value 105 and the associated timestamp 106. See FIG. 4. Filtered samples 104 are output at a reduced data rate, while prioritizing rapidly changing data over stagnate data. See FIG. 5 for an example of a filtered sample.

Key to this process in one possible embodiment is the update rate curve 108. See FIG. 6. The update rate curve 108 dictates an update time 106 based on the amount the new sample's value 105 has changed from the last reported or filtered sample's value. In one embodiment, the adaptive sampling system 104 encompasses a diverse range of update rate curves 108, allowing for versatile adaptation to specific application requirements as an application-specific rate curve. See FIG. 6. In other words, that system that can be specifically customized according to an application-specific rate curve in one possible embodiment. In addition to different values 105, alternative embodiments of these curves may also adopt various forms, including linear, piecewise 109, or curved representations, such as polynomials or exponentials. Curves may take the form of a table-lookup/interpolation 115, or via established equations such as linear form, piecewise form, and curved form.
Linear Form: In one embodiment, the update rate curve may take a linear form, providing a straightforward relationship between the rate of change in the data and the resulting update time. This linear model is conducive to simplicity and ease of interpretation.
Piecewise Form: In one embodiment, the update rate curve may be structured in a piecewise manner, accommodating distinct regions with different characteristics. This enables tailored adjustments to the update rate based on specific conditions or data patterns.
Curved Form: In one embodiment, update rate curves, characterized by mathematical functions such as polynomials or exponentials, can be employed. These curved forms offer flexibility in capturing intricate relationships between the rate of change and the desired update time.

One possible embodiment of the adaptive sampling system also provides the flexibility to incorporate directional sensitivity into an update rate determination. Rather than considering the absolute change in value alone, the process can be configured to prioritize a faster update rate based on the direction of change. This feature is particularly valuable in applications where the directionality of the data change holds significance. For the sake of simplicity, the absolute value of the change will be shown in the following illustrations.

In one embodiment, the update rate curve 108 not only governs the timing of subsequent samples but also serves as a customizable parameter influencing the fidelity of the filtered data concerning the original high-speed data. By adjusting the shape and characteristics of this curve, users can influence the number of samples retained in the downsampling process 104, thereby fine-tuning the balance between data accuracy and resource efficiency.

In one embodiment, this flexibility in update rate curve 108 design empowers users to tailor the adaptive sampling system to the specific demands of diverse applications, ensuring optimal performance across a spectrum of data dynamics.

Additional flexibility in one embodiment of this adaptive sampling system can be achieved by using a 3-dimensional curve. If a safety limit is being approached or exceeded, increase the rates at all points on the curve so the additional axis would be the distance to the safety limit. The adaptive sampling system in this way adapts sample rates on physical conditions 102 in the environment. In one embodiment, some processes may be more inherently risky during higher temperatures, and the implementor would desire a more aggressive update rate with increased temperature.

Additionally, in one embodiment, a constant update rate just becomes a special case of this general implementation. To achieve a constant update rate, one must simply define a flat curve, allowing extrapolation beyond the curve limits. If the system designer desires a flat update rate, no additional work may be required. This allows the system developer to use this same solution in cases where a flat update rate is desired and when a dynamic update is required without modification beyond the definition of the curve.

Additionally, in one embodiment, a constant update rate just becomes a special case of this general implementation. To achieve a constant update rate, one must simply define a flat curve, allowing extrapolation beyond the curve limits. If the system designer desires a flat update rate, no additional work may be required. This allows the system developer to use this same solution in cases where a flat update rate is desired and when a dynamic update is required without modification beyond the definition of the curve.

The anticipated process for implementing one embodiment would include creating a flat curve at high sample rate. Once representative data is collected it can be post processed using this process. Adjustments to the shape of the curve can be performed until a satisfactory tradeoff between number of samples and fit fidelity can be arrived at. Implementation of automatic feedback loops that allow the system to adjust its performance based on the downstream processing or display requirements, ensuring optimal data utility are achievable.

In one aspect, the following details a process of intelligent downsampling 104 high speed data:

$${[ Filtered Sample ]}_{n} = \vert \begin{matrix}if ( {[ New Sample \cdot Time Stamp ]}_{n} \geq {[ Min of Update Time Plus Current Time and Time for next update ]}_{n} ) \\ \{ \begin{matrix}then : New Sample \\ else {: [ Filtered Sample ]}_{n - 1}\end{matrix}\end{matrix}$$

Where n is the current iteration, and n−1 is the previous iteration of high speed data and . . . .

Key, is the ability to notify downstream systems when an update is required. Possible examples would include using such notifications to determine when to transmit data, display, and when to store data.

$$Update required = if ( {[ New Sample \cdot Time Stamp ]}_{n} \geq {[ Min of Update Time Plus Current Time and Time for next update ]}_{n} )$$

$$Where$$

$${[ Update Time In Seconds ]}_{n} = {f}_{update curve} ( {[ \vert Delta from Last \vert ]}_{n} )$$

*In alternative implementations, taking an absolute value may not be required. And where

$$Sample Update {Timestamp}_{n} = {[ Update Time In Seconds ]}_{n} + {[ New Sample \cdot Timestamp ]}_{n}$$

$$And where …$$

$${[ Delta from Last ]}_{n} = {[ New Sample \cdot value ]}_{n} - {[ Filtered Sample Value ]}_{n - 1}$$

$$And where$$

$${[ Min of Update Time Plus Current Time and Time for next update ]}_{n} = minimum ( [ Sample Update {Timestamp}_{n} ] , {[ Time for next update ]}_{n - 1}$$

$$And where$$

$${[ Time for next update ]}_{n} = \vert \begin{matrix}if ( {[ New Sample \cdot Time Stamp ]}_{n} \geq {[ Min of Update Time Plus Current Time and Time for next update ]}_{n} ) \\ \{ \begin{matrix}then {: [ Min of Update Time Plus Current Time and Time for next update ]}_{n} \\ else {: [ Time for next update ]}_{n - 1}\end{matrix}\end{matrix}$$

By way of an illustrative process in one embodiment within the inventive system, and as seen in FIG. 7, one implementation for a method of adaptive sampling system might involve the following illustrative steps. The first step 109 involves a new sample 107 that comprises a numerical value 105 and a timestamp 106. This new sample 107 is passed to the adaptive sampling system in FIG. 7. The second step 110 is to compute the difference in values between the numerical value 105 from step 1 and the last reported numerical value from this process. For example, if the last reported value was 23.5 and the new sample 107 from the high-speed acquisition system 103 had the numerical value of 25, a computed value delta equals 1.5. The third step 111 is to input the computed value delta into the table lookup/interpolation 115. From the Update Rate Curve 108 we compute a new update time for this new sample 107. If we use the computed value delta of 1.5 from the second step 110 as an example, and the Update Rate Curve 108 from FIG. 6 as an example, we′d output 0.15 seconds. The fourth step 112 is to add the time in seconds computed in the third step 111 to the timestamp 106 of the newest incoming sample off the high-speed Acquisition Device. This is to give us a timestamp in the future when we need to perform a potential update. In FIG. 7, this is referred to as a Sample Update Timestamp 119. The fifth step 113 is to compare the Sample Update Timestamp 119 computed in the fourth step 112 to the Sample Update Timestamp calculated in the last iteration of this process and use whichever Sample Update Timestamp is less 120 to proceed to the sixth step 114. In other words, if the new Sample Update Timestamp computed is smaller, we now use the new Sample Update Timestamp; however, if an old Sample Update Timestamp computed is smaller, we use the older Sample Update Timestamp. Because data with a larger value delta computed in the second step 110 will have a shorter update, it is in this way, the process can update faster when more rapidly changing data values are inputted into the system. The sixth step 114 is to determine if the computed update time has expired. The Sample Update Timestamp 119 from the fifth step 113 is compared to the Sample Update Timestamp of the incoming sample from the high-speed data acquisition system 103. If the timestamp from the incoming high-speed acquisition system is later, the update time has expired and we know we must do three things: 1) We activate the “update is required” flag to let the downstream system know to record this new data 2) We update the “Filtered Sample” 121, replacing the object with the incoming sample off the high-speed acquisition system. 3) We use the update time computed for the new sample in the fourth step 112, as the new “Time for Next Update”, as the old one has now expired. However, if the timestamp from the incoming sample off the high-speed acquisition system is less than the value computed in the fifth step 113, the update time has not expired yet. We then keep 1) Keep the “Update Required” flag off, so the downstream systems can continue their idle state 2) We keep the Filtered Sample from the last iteration, as it has not updated, and 3) The “Time for Next Update” is set to the value computed in fifth step 113. In an embodiment of software implementation using LabVIEW Implementation for the adaptive sampling system, the illustrative six steps above are written as software code. See FIG. 42.

In one embodiment, the chart in FIG. 8 compares the high-speed data collection of raw data 128 with data filtered 130 by the adaptive sampling system 104, one can effectively disregard statistically insignificant signal changes. For instance, the curve can be intricately linked to percentages of a calibration tolerance. When alterations in the signal are merely a small fraction of the calibration tolerance, it can be asserted that the signal has not changed in a statistically significant manner. This eliminates the necessity for cumbersome pre-processing steps, allowing for a more streamlined and robust implementation of the adaptive scheme. The effectiveness of this downsampling process 104 is particularly evident in its adaptive nature. In regions where the data undergoes rapid changes, the downsampling process 104 ensures higher fidelity, requiring only a minimal number of samples in portions where the data changes slowly. This adaptability is attributed to the utilization of a sample rate curve, which can be modified to enhance fidelity as needed.

For example in one embodiment, a simulated thermocouple with a noise signal will be provided to illustrate the rate of the adaptive sampling system. See FIG. 9 for a simulated thermocouple at a steady state. One line indicates an actual High Speed data collection 128 while the other line indicates the filtered/decimated data 130 created using adaptive sampling system 104. As a typical thermocouple has an accuracy on the order of 2° F., changes on the magnitude of ¼^{th} this are statistically insignificant (0.5° F.). Hence the application-specific rate curve is an update rate curve 108 chosen to give a balance of good response, limited sample updates, and ensuring errors are insignificant. Any triangle 129 at the bottom of the graph in FIG. 9, FIG. 10, FIG. 11, and FIG. 12 denote new or updated data on the inventive downsampled output. These updates represent only approximately 5%-15% of the samples of the original waveform while still giving good fidelity of the original signal. However, in FIG. 10 is a response of a simulated thermocouple with a rapid rise in temperature when the high speed data 128 is compared to the decimated/filtered data 130 using the adaptive sampling system 104. If the static updates from FIG. 9 were used, almost all the fidelity of the transient update would have been lost. In response of a simulated thermocouple with a rapid drop in temperature with the faster updates in the transient when the high speed data 128 is compared to the decimated/filtered data 130 using the adaptive sampling system 104. The differences are statistically insignificant despite less data collected. See FIG. 11. A response of a Simulated Thermocouple with a slow rise in temperature when the high speed data 128 is compared to the decimated/filtered data 130 using the adaptive sampling system 104. See FIG. 12. The differences are statistically insignificant despite less data collected.

In one embodiment from an aircraft engine case study, high-speed telemetry was stored of the event at a speed of 100 samples/second for each example in FIG. 15-FIG. 18. When the raw high speed data 128 is compared to the decimated/filtered data 130 using the adaptive sampling system 104, only a fraction of the original data is required to give an excellent representation of the data in those examples. An Update Rate Curve 108 was created using T5 temperature from that event. See FIG. 14. The data was stored rounded to the whole number and has a calibration tolerance of 2° F. With even the most basic of curve implementation, the process reduced the number of samples stored in the event from 60,000 to 7,017 (11.7% of the original data) while effectively having no loss in data fidelity when the high speed data 128 is compared to the decimated/filtered data 130 using the adaptive sampling system 104 through a period of time. See FIG. 15-FIG. 19. In fact, in FIG. 15, FIG. 17, and FIG. 18, the raw high speed data 128 and decimated/filtered data 130 using the adaptive sampling system 104 overlap completely.

In another embodiment from the aircraft engine case study, for measurements 101 in rough industrial processes like System Hydraulic pressure, the improvement is much more pronounced. It has a calibration tolerance of 10 PSI is appropriate. Even with an aggressive updated rate curve 108 in FIG. 20 associated with the application-specific rate curve, the number of samples needed to produce a high-fidelity representation of the signal drops from 60,000 samples to 1,375 samples (or 2.3% of the original data) when the high speed data 128 is compared to the decimated/filtered data 130 using the adaptive sampling system 104 through a period of time. See FIG. 21-FIG. 25. In fact, in FIG. 21, the raw high speed data 128 and decimated/filtered data 130 using the adaptive sampling system 104 overlap completely.

In another embodiment from the aircraft engine case study, physical conditions 102 like power turbine speed use an adjusted update rate curve 108 to give a quicker response and faster updates. Power turbine speed uses a calibration tolerance of around 10 RPM. We can adjust the update rate curve 108 to give a quicker response and faster updates. See FIG. 26. In this example, we adjust the curves such that we only allow 11,025 samples through the filter, compared to the 60,000 original samples (18.4% of the original amount) while giving excellent fidelity of the original signal when the high speed data 128 is compared to the decimated/filtered data 130 using the adaptive sampling system 104 through a period of time. See FIG. 27-31. In fact, in FIG. 27 and FIG. 30, the raw high speed data 128 and decimated/filtered data 130 using the adaptive sampling system 104 overlap completely.

In another embodiment from the aircraft engine case study, physical conditions 102 like pressure also use a reduced number of samples. Pressure as PS2 has a calibration tolerance of 0.06 Inches of Water. As pressure is considered critical to various calculations, so fidelity is prioritized over sample reduction with a more cautious updated rate curve 108 in FIG. 32. Even so, we are still able to reduce the total number of samples reported to 11,194 from 60,000 sample (18.7% of the original number of samples) when the high speed data 128 is compared to the decimated/filtered data 130 using the adaptive sampling system 104 through a period of time. See FIG. 33-FIG. 37. In fact, in FIG. 33 and FIG. 34, the raw high speed data 128 and decimated/filtered data 130 using the adaptive sampling system 104 overlap completely.

In one embodiment, we can compare the adaptive sampling system in FIG. 38 to traditional downsampling method used in FIG. 39 where the static update rate would give approximately the same number of samples, but evenly spaced using the real Power Turbine Speed data. An area of rapid change was shown in FIG. 38 and zoomed in to illustrate the improved performance of the adaptive sample rate method in these transients in FIG. 39. The high speed data 128 is compared to the decimated/filtered data 130 using the adaptive sampling system 104 through a period of time in FIG. 38. However, in FIG. 39, traditional downsampling is used with the same number of samples in FIG. 38, but not dynamically spaced in time.

In one embodiment of hardware implementation with a temperature probe, an Arduino Uno 122 provides processing and serial communication with a Maxim MAX6675 123 integrated circuit. See FIG. 14. The Maxim MAX6675 123 provides signal conditioning and digitization via SPI (Serial Peripheral Interface) and is housed on a breakout board with a K-type thermocouple 124 connected. The Arduino Uno 122 is connected to a laptop 125 via USB (Universal Serial Bus) 126. The Arduino Uno has a built-in USB to UART converter. The laptop can capture the ASCII UART (Universal Asynchronous Receiver-Transmitter) data stream from the Arduino by monitoring/dev/ttyUSBx (device files/USB Serial Port Adapter). See FIG. 14. Another embodiment could feature components integrated onto a single PCB (Printed Circuit Board). Additional mechanical packaging of the probe would be required to fit the final application. The Arduino was programmed by modifying the MAX6675 example from https://www.adafruit.com to provide the temperature data stream and implementing the novel down-sampling methodology in the Arduino C/C++ programming language. The internal acquisition speed of the Arduino was set to 250 milliseconds. Pin 4 was set to Data Out (DO). Pin 5 was set to Chip Select (CS). Pin 6 was set to Serial Clock (CLK). A special limits of error K-Type thermocouple for this example of an embodiment, the curve was configured such that if the temperature changes by more than the calibration tolerance, the update rate was set to the fastest possible (250 ms). At half the calibration tolerance, the update rate was set to 10 times (˜2.5 s) the fastest possible. With no change, the update rate was set to 50 times the fastest possible (10 sec). The rationale for this implementation is that changes in temperature that represent fractions of the probe's accuracy are effectively the same measurement, and thus, slowing down the sample rates can be justified for most applications. When the measurements change rapidly, the system prioritizes this data and increases the sample rates. To demonstrate this, the probe was placed into hot water, then removed and placed into cold water, and finally placed back into the hot water. The serial output from the temperature probe was captured and plotted below in FIG. 40. For that embodiment, when the measurements change rapidly, the system prioritizes this data and increases the sample rates. However, when the probe was initially placed in either the hot or cold water, the temperature rose or fell rapidly and the system transmitted data with much shorter intervals. This test took approximately 248 seconds. During this time, only 163 data points were transmitted over USB/UART. At the time of the most rapid temperature 127 change, these samples were as close as 250 ms apart in time. See FIG. 41.

In contrast, during near steady-state conditions, these samples were at times as much as four (4) seconds apart. To achieve the same fidelity in this data with a constant update rate (which is traditionally employed) the update rate would need to be set to the shortest interval we saw in this data set (250 ms). In this case, it would have been necessary to transmit almost 1000 data points. By spacing out the 163 data points to times when the data was of greater significance, it was possible to achieve the effective fidelity of the traditional sampling technique while transmitting only approximately 16% of the data. This reduction translates into savings in bandwidth (allowing more sensors to be added), downstream processing, data storage, and other related areas.

All such modifications and variations are within the scope of the invention as determined by the appended claims when interpreted in accordance with the breadth to which they are fairly, legally, and equitably entitled.

The invention claimed is:

1. An adaptive sampling system for generating downsampled time-variant numerical measurements of physical conditions, said adaptive sampling system comprising:
A customized programmable application specific logic array,
said customized programmable application specific logic array being specifically customized according to an application-specific rate curve embedded within the customized programmable application specific logic array,
said customized programmable application specific logic array producing an update rate used for downsampling as a function of said application-specific rate curve and a magnitude of error of last reported value;
at least one customized aperiodic measurement sensor in communication with said customized programmable application specific logic array;
said customized aperiodic measurement sensor having at least one specific sensor for sensing numerical values representing measurements of physical conditions;
said customized time variant, aperiodic measurement sensor having customized programmable sensor logic that adjusts for time-variant based updating of said numerical values as regulated by said customized programmable application specific logic array; and
an output module in communication with said aperiodic measurement sensor for outputting said numerical values of physical conditions on an aperiodic variable time schedule.

2. The adaptive sampling system of claim 1, wherein said measurements of physical conditions are chosen from the group comprising at least one of the following aperiodic, time variant numerical values of: temperature, torque, angular position, speed/velocity, pressure under fluctuating environmental conditions, or flow rate under fluctuating environmental conditions, humidity, viscosity, electrical conductivity, voltage, current, magnetic flux density, luminous intensity, radiation levels, sound pressure levels, soil moisture content, air quality index, strain, particle flux, particle concentration in a medium, wind speed, salinity, pH level, wave height, solar irradiance, thickness, length, distance, dew point, barometric pressure, concentration of gas levels, concentration of fluid levels, displacement, cloud cover, atmospheric visibility, heat flux, leave area index, vapor pressure, Albedo, ground water depth, electromagnetic field strength, bioluminescence intensity, evaporation rate, acceleration, objects/items/people that occupy a given area, aerosol optical depth, electrical resistance, Reynolds number, capacitance, or inductance.

3. The adaptive sampling system of claim 2, wherein said application-specific rate curve embedded within the customized programmable application specific logic array is chosen from the group comprising linear form, piecewise form, or curved form.

4. The adaptive sampling system of claim 3, wherein said application-specific rate curve embedded within the customized programmable application specific logic array further includes a 3-D curve built from safety parameters.

5. The adaptive sampling system of claim 2, wherein at least one specific sensor is embedded into at least one customized aperiodic measurement sensor and that specific sensor is regulated by said customized programmable application specific logic array.

6. A method for adaptive sampling, comprising:
depositing a signal to a high speed data acquisition system to digitize that signal with a time stamp to create a current sample;
providing a data processing display to compare values from the current sample with a previous sample for a delta;
inserting that delta into a table lookup to use an Update Rate Curve to find a new update time;
calculating a Sample Update Timestamp to perform a potential subsequent update through addition of the new update time to a timestamp of an incoming sample off a high-speed data acquisition device;
comparing the Sample Update Timestamp to a recorded time of a previous Sample Update Timestamp to use whatever timestamp out of the two timestamps has the shortest time; and
receiving that timestamp to compare with a subsequent timestamp of an incoming sample from the high-speed acquisition system and only when that subsequent timestamp of the incoming sample is greater, a downstream system must record new data from a new sample off the high-speed acquisition system, replace the object with the incoming sample, and replace the new update time with a time from that incoming sample.
